(19) United States
(12) Patent Application Publication
(10) Pub. No.: US 2026/0244831 A1
(43) Pub. Date: Aug. 20, 2026

(54) ARGUMENT OPTIMIZATION AND FEEDBACK DETECTION FOR LLM SIMULATION EVALUATION

(71) Applicant: VerdictHub, Highland Village, TX (US)

(72) Inventors: SWARUP ACHARYA, Summit, NJ (US); GAURAV TIWARI, Mercer Island, WA (US); TROY HIRSCHHORN, Sherman Oaks, CA (US)

(73) Assignee: VERDICTHUB, Highland Village, TX (US)

(21) Appl. No.: 19/544,764

(22) Filed: Feb. 19, 2026

Related U.S. Application Data
(60) Provisional application No. 63/760,605, filed on Feb. 19, 2025.
(60) Provisional application No. 63/760,603, filed on Feb. 19, 2025.
(60) Provisional application No. 63/760,548, filed on Feb. 19, 2025.
(60) Provisional application No. 63/760,151, filed on Feb. 19, 2025.

(51) Int. Cl. G06F 30/27

(52) U.S. Cl. CPC G06F 30/27

(57) ABSTRACT

LLM improvements are disclosed relating to simulated dispute evaluation. By establishing a stateless digital dispute evaluator, multiple different scenarios can be evaluated. Such scenarios may differ as to their specifics (e.g. arguments applicable in one scenario vs. another scenario). Differing argument parameters may lead to disparate simulated evaluation scenario outcomes. Outcome optimization information may be generated as a result of simulated evaluation analysis where multiple scenarios may be present.

### BACKGROUND

Decision modeling using computing technology can be a challenging endeavor. Certain decision making processes have never been effectively modeled in a way that provides sound and accurate results.

In recent years, artificial intelligence (AI) techniques, including computation via large language models (LLMs), have been used for various purposes. Applicant recognizes, however, that despite the availability of AI techniques, obstacles remain with regard to their effectiveness.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example of a computing environment in which examples of the disclosed technology may be implemented.

FIG. 2 illustrates an example of a flow of operations between an orchestration system and an LLM set.

FIG. 3 illustrates an example of a software architecture usable with various structures and techniques relating to simulation evaluation.

FIG. 4 illustrates an example of a dispute evaluator and associated components as may be used for simulation evaluation in the context of an LLM architecture.

FIG. 5 illustrates an example of case documents as may be used in relation to simulating an outcome of a legal dispute.

FIG. 6 is an example illustrating a flow of certain operations of a case summary module.

FIGS. 7A and 7B illustrate examples regarding flows of certain operations of an evaluation form module.

FIGS. 8A, 8B, and 8C illustrate an example regarding flows of certain operations of a report generation module.

FIG. 9 illustrates an example regarding flows of certain operations of an audio generation module.

FIG. 10 illustrates an example of a flowchart for a method relating to obtaining simulated outcome data as may occur in the context of a heterogenous LLM set.

FIG. 11 illustrates an example of a flowchart for a method relating to argument optimization in the context of a dispute as may occur in the context of a heterogenous LLM set.

FIG. 12 illustrates an example of a flowchart for a method relating to determining neutrality of input for a simulated evaluation of a dispute as may occur in the context of a heterogenous LLM set.

FIG. 13 illustrates an example of a flowchart for a method relating to workflow configurations and particular functional tasks related to simulated dispute evaluation, as may occur in the context of a heterogenous LLM set.

FIG. 14 illustrates an example of a flowchart for a method relating to generation of synthetic audio content as may be used in connection with simulated dispute evaluation, according to some embodiments.

FIG. 15 illustrates a block diagram of an example computer system in which various examples of the disclosed technology described herein may be implemented.

The figures are not exhaustive and do not limit the present disclosure to the particular form(s) disclosed.

### DETAILED DESCRIPTION

In attempting to provide a technology-based model that is reflective of real world conditions, various difficulties may be encountered. The more complex that a real world process is, the greater these difficulties may be. Computing resource usage is also negatively affected when a modeling process is inaccurate or ineffective, by wasting compute cycles, electricity, network bandwidth, wear and tear on computing components such as hard drives, and other resource usage. Modeling for certain real world processes, such as a complex evaluation of a dispute in particular, may be significantly improved-and may be impossible to perform by other means such as the human mind. By creating an effective model of a real world process, however, a process can be better understood which enables more efficient use of computing resources. In regard to a real world process that involves human activity, it may be especially challenging to build a technology-driven model that is reflective of many nuances that factor into the outcome of the process.

One example of a complex process involving human activity relates to a legal dispute, which may be between two or more parties. In the United States and in many countries worldwide, legal disputes are often decided by a jury. A jury may view and weigh evidence and ultimately render a verdict-making a decision on liability and monetary damages in a civil dispute, for example, or rendering a verdict of guilty or not guilty in a criminal case. Other real world evaluation mechanisms for legal disputes exist as well, including arbitration, mediation, or a judge deciding a case.

One way of attempting to model decision making that occurs in the evaluation of a legal dispute is to use a human jury consultant, whose expertise may be combined with a mock jury. A human jury consultant may have behavioral insight into common reasons why a jury is likely to make a particular decision. A mock jury composed of real people, meanwhile, can provide a mock verdict, and may be able to explain some of the reasons they had in reaching a particular decision.

Jury consultants and mock juries can be particularly helpful in high-stakes civil disputes where many millions of dollars are at stake, or when a criminal defendant may be facing serious charges. These human-based techniques have limitations, however. One non-technical limitation of using jury consultants and mock juries is cost. Highly experienced jury consultants may add significant value to a party in a legal dispute, but can be expensive to use. It may make economic sense to use an experienced jury consultant on a case where fifty million dollars ($50 M) is at stake, but it may be cost-prohibitive to do so when the value of a case is on a lower order, such as $75,000.

Human mock juries have limitations regarding memory, however, which cannot be overcome without the use of technology such as disclosed herein. A human mind cannot simply be wiped clean to an initial state. Humans have memories that will retain information previously presented to them. Once a human mock juror is exposed to an evidentiary fact or a particular legal argument, they cannot simply choose not to remember that fact or argument, even if instructed to do so. That fact or argument instead will still play a conscious or unconscious role in future evaluation. Digital evaluators (e.g. digital juror personas) used herein, however, can be reset to a starting state, or to any desired state. Thus, digital dispute evaluation as disclosed herein provides a unique advantage over prior human mock jury techniques—an advantage that simply cannot be obtained through use of human mental processes.

As an example, consider a civil case in which ABC Company is suing XYZ Company for a breach of contract, and seeking $100 M in damages. One piece of potential evidence in this case is an email from the President of XYZ. The email states “I don't care what the contract says. I don't care if ABC gets their equipment order on time—we can sell these units RIGHT NOW to BigCo., and double our profits. Make the sale to BigCo happen!! We can worry about ABC later.” Most people would consider such email evidence to be very unfavorable to XYZ Company. There may be some doubt, however, as to whether this particular piece of email evidence will be admitted at trial or if it will instead be excluded by a judge and not heard by a jury.

Consider a human mock jury that is made aware of this email evidence above in a first mock trial, and decides to award $85 M in damages to ABC Company. A second mock trial is run, in which the same mock jury is told to forget everything that they heard in the first mock trial—this is a fresh start to see what their decision would be when different evidence is presented. In the second mock trial, the email evidence is not shown to the mock jury, and they decide to award $53 M in damages to ABC Company (rather than the original $85 M). The results of the second human mock trial in this example may be inaccurate, because there is no way of knowing whether the mock jury—who saw the email in the first mock trial—was actually able to disregard its existence. Many different permutations of this scenario are possible and can occur when attempting to evaluate the impacts that different facts or arguments may have on a dispute's outcome.

Fundamentally, one cannot make a “first impression” twice. The human mind, after having been exposed to certain facts or arguments, will naturally retain some knowledge of those facts or arguments. Thus, attempting to use the same human mock jury for multiple permutations of evidence and legal arguments may be an inherently impossible task if trying to provide accurate results—human mock juries may have great value, but this is something they cannot accomplish. However, technology-driven modeling as disclosed herein provides functional capabilities that do not exist with regard to human mock juries, as a digital mock jury can be modeled statelessly. That is, unlike a human mind, the “memory” of a digital mock juror can be wiped clean, and innumerable different versions of a legal dispute can be presented to a digital mock juror without inadvertent bias occurring based on what has been presented to that digital mock juror in the past.

Another possible solution to the issue of first impression on a human mock jury would be to employ multiple different human mock juries, each with a different composition. This might be quite costly, but could allow for “first impression” assessments of multiple different variations on evidence and argument. However, such a solution still would not achieve what a digital mock jury can achieve via the present techniques. The exact same digital mock jury (with its particular compositional characteristics) can be used to evaluate multiple case permutations on a bias-free basis as discussed herein. But when a different case permutation is used on a different human mock jury to achieve a true “first impression”, it may be impossible to truly know how much, if any, of a difference between verdicts is due to the different human composition of the first and second mock juries versus a presentation of different arguments or evidence.

As used herein, the term “dispute” or “legal dispute” refers to any set of circumstances (actual, hypothetical, or a combination thereof) in which at least one party (e.g. an individual, a company, a government, or other entity) is partially or wholly in opposition to another party. A dispute may refer to a currently pending legal action, such as a case filed in court, a case in arbitration, a case in mediation, or a contemplated legal action (e.g. a potential case which has not yet been filed in court or has not yet entered into an arbitration or mediation process). Non-limiting examples of a “dispute” thus include a first company that has sued or is considering suing another company in court for damages and/or an injunction, an individual who has been charged or may be charged with a criminal offense by a local, state, or federal government, a potential class action lawsuit by a group of plaintiffs against a group of defendants, etc.

The following detailed description provides illustrative examples and embodiments of the disclosed subject matter to facilitate understanding of the principles and applications involved. The disclosed subject matter generally relates to systems and methods for leveraging artificial intelligence, particularly large language models (LLMs), in legal analysis and trial preparation, argument optimization, content neutrality analysis, and synthetic audio generation, in various embodiments. These systems are designed to enhance the efficiency, accuracy, and adaptability of legal processes, including mock trial simulations, jury research, and strategic decision-making. While specific examples and implementations are described herein, they are provided for illustrative purposes only and are not intended to limit the scope of the disclosed subject matter. Further, techniques disclosed herein are explicitly not limited to embodiments in which a legal dispute. Some or all aspects of the disclosed technology may be used in a number of different settings.

It is to be understood that certain widely recognized elements, processes, and techniques may not be described in detail to prevent obscuring the subject matter disclosed. Furthermore, various adjustments, rearrangements, or substitutions of components and steps may be implemented without deviating from the spirit and scope of the disclosed subject matter. The described embodiments aim to encompass all such alternatives, modifications, and equivalents that may fall within the scope of the claims.

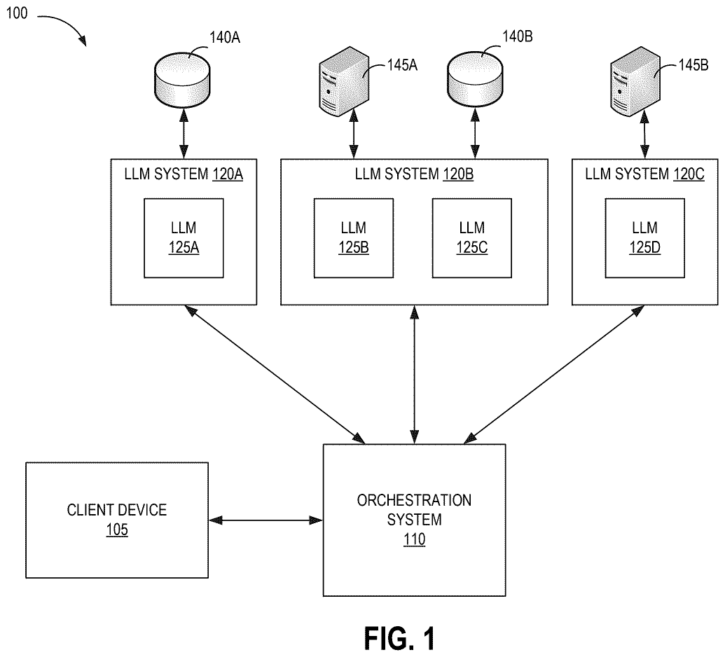

Before describing examples of the disclosed systems and methods in detail, it is useful to describe an example network installation with which these systems and methods might be implemented in various applications. FIG. 1 illustrates one example of a computing environment 100 that may be implemented relative to an individual or an organization, such as a business, educational institution, governmental entity, healthcare facility or other organization.

Client device 105 may be a variety of computing devices or combination of devices in various embodiments, such as a smartphone, laptop computer, desktop computer, server, workstation, etc. A user of client device 105 may interact with orchestration system 110 in order to accomplish various tasks.

Orchestration system 110 and LLM systems 120 may likewise respectively be any suitable computing device or combination of devices. In various embodiments, system 110 interacts with a number of different large language model (LLM) systems 120A, 120B, and 120C (collectively “LLM systems 120”). Note that while three LLM systems are shown, there may be greater or fewer according to some embodiments and use cases. LLM systems 120 may be hosted within one or more cloud computing environments in some instances, and may also by controlled or operated by a different entity than an entity that controls or operates orchestration system 110 or client device 105.

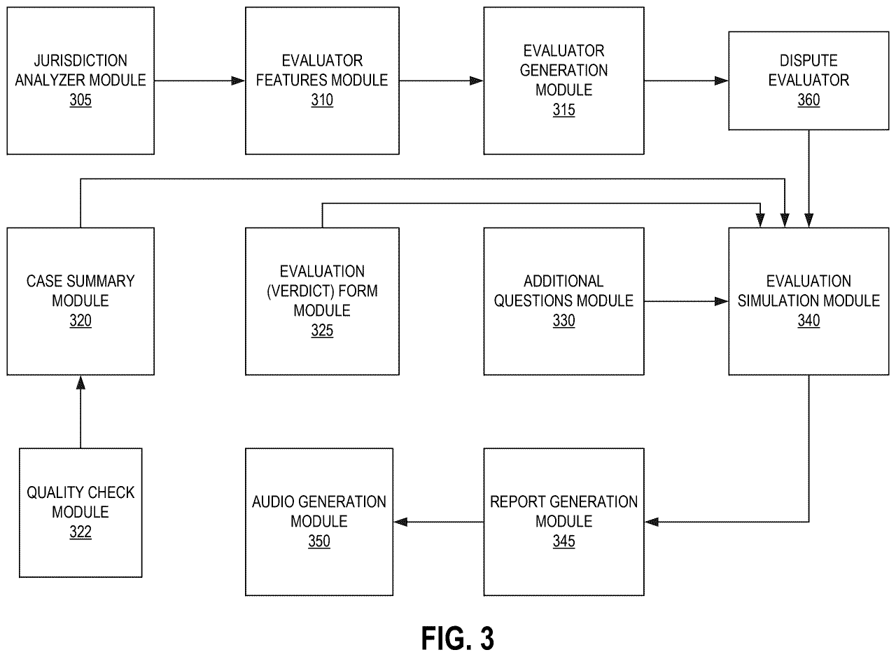

Orchestration system 110 may perform a variety of different operations in various embodiments, including any or all portions of various techniques described herein. Orchestration system 110 may also include various modules (e.g. as described relative to FIG. 3). In some instances, orchestration system 110 may thus perform all steps of particular disclosed methods, while in other instances, orchestration system 110 may perform part of those methods while another system performs another part of those methods. In yet other embodiments, a system other than orchestration system 110 may perform all steps of methods disclosed herein. Orchestration system 110 may include a single computer (e.g. a laptop, desktop, server, etc.), or may include multiple computers (e.g. two or more machines configured to communicate via a network) according to various embodiments.

Each of LLM systems 120 may host a different instance of an LLM. As shown, LLM system 120A hosts LLM 125A, LLM system 120B hosts LLMs 125B and 125C, while LLM system 120C hosts LLM 125D. (As used herein, “LLM 125” may refer to any of LLMs 125A-125D, while “LLMs 125” may refer to any two or more of LLMs 125A-125D, for example). According to various embodiments, an LLM system may host any number of LLM instances. In some embodiments, an LLM instance can also be hosted by two or more LLM systems 120 (which may be connected via a network). Various system configuration are therefore possible with respect to LLMs and LLM systems upon which they are hosted. Structure and functionality described herein with respect to any particular one of LLM systems 120A-120C is applicable to the other LLM systems, according to various embodiments. Structure and functionality described herein with respect to any particular one of LLMs 125A-125D is also applicable to the other LLMs, according to various embodiments. Thus, as an example, functionality described with respect to LLM system 120A may also be applicable to LLM system 120B or 120C, while functionality described with respect to LLM 125A may also be applicable to one or more of LLMs 125B, 125C, or 125D.

As shown, LLM 125A includes stored executable computer instructions operable to perform one or more computational tasks based at least in part on natural language input (e.g. English or some other language). Thus, LLM 125A is operable to receive a general purpose input, and produce a variety of corresponding outputs in some embodiments. Input data to LLM 125A may include one or more natural languages (e.g. English, Spanish, Mandarin, etc.), but any other kind of input data as well, including but not limited to one or more of text, audio, video, still images, animated images, structured or unstructured data, spreadsheets, source code, script code, pseudocode, executable code, parameters, weighting information, etc. Input to LLM 125A may include one or more files in a variety of different formats. Input to LLM 125A may include a single type of data, or a mix of two or more types of data. Thus, input to LLM 125A may include natural language along with non-natural language data (which may be referenced or otherwise operated on by LLM 125A). Output data from LLM 125A may be anything described with respect to input data above, according to various embodiments.

LLM 125A is trained to process input data and produce output data, in some embodiments, according to various artificial intelligence (Al) and machine learning (ML) techniques. LLMs 125 are a heterogenous set of LLMs in various embodiments, in that two or more instances of an LLM 125 will be different from one another. A first LLM is considered “different” from another second LLM herein if the first LLM does not behave identically to the second LLM on all possible sets of input data. Factors that may cause a first LLM to be different from a second LLM can include, but are not limited to, one or more different training algorithms being used to train the LLMs, one or more different sets of underlying data being used to train the LLMs, one or more different execution algorithms being used by the LLMs, or one or more deployment differences existing between the LLMs (e.g. a difference between LLMs 125A and 125B may exist due to a difference between LLM system 120A and LLM system 120B on which those LLMs are deployed).

LLMs 125, as well as LLM systems 120, may correspond to various different entities in some embodiments. As an example, LLM 125A may be an instance of the CLAUDE™ LLM (developed by ANTHROPHIC™), while LLM 125B may be an instance of the CHATGPT™ LLM (developed by OPENAI™). Note that LLMs 125 may still be considered different from one another when they are based on the same underlying model (e.g., developed by the same entity) if those LLMs are of different versions, were trained on different underlying data, or otherwise behave differently in at least some respects.

Orchestration system 110 and client device 105 are operated by and/or correspond to different entities than an entity associated with LLM system 120A and/or LLM 125A, according to some embodiments. As just one example, client device 105 may correspond to an end user (such as a party involved in a legal dispute or an attorney representing the party), orchestration system 110 may correspond to a company using the presently disclosed technology, LLM 125A may correspond to an entity that developed a particular version of a large language model, and LLM system 120A may correspond to an entity that operates a cloud computing service. Various such configurations regarding system and LLM deployment are possible and contemplated.

LLM systems 120 are also configured to interact with other computer systems and/or data sources in various embodiments. For example, an LLM system 120 may be connected to and retrieve data from the Internet, a relational database system, or another network or computer system. As depicted, LLM systems 120A and 120B are respectively configured to connect to databases 140A and 140B, while LLM systems 120B and 120C are respectively configured to connect to server systems 145A and 145B. An LLM system 120 may execute a computing task or otherwise perform computing operations via external systems (e.g. 140A, 140B, 145A, 145B) in different embodiments, including providing particular queries or instructions to such systems and receiving data or computational results from such systems. Various different configurations are possible and contemplated with regard to connections by LLM systems 120 to other external systems. Such external systems may include, but are not limited to, desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

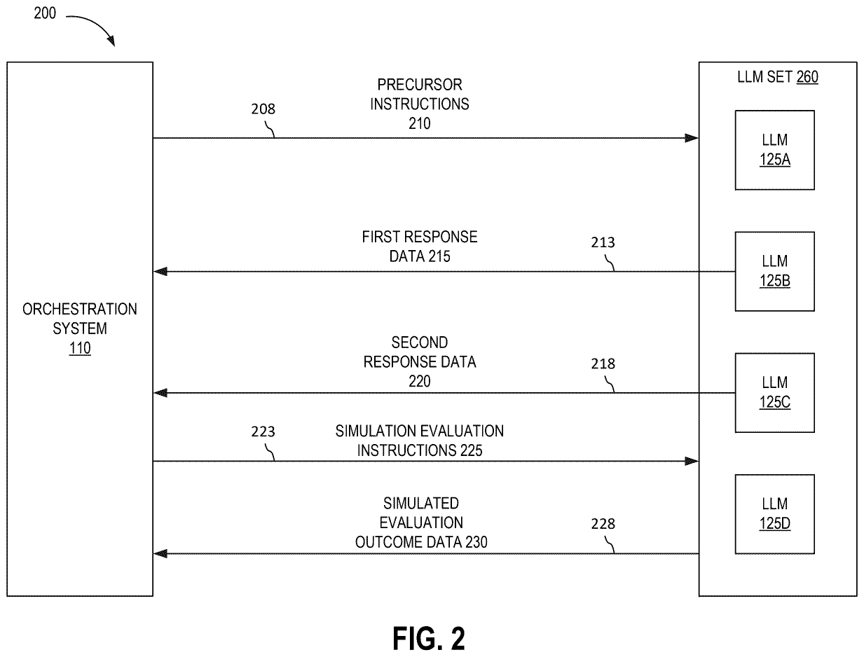

FIG. 2 shows one example 200 of a flow of operations between orchestration system 110 and an LLM set 210. This example relates to how orchestration system 110 may determine a simulated outcome of a legal dispute, according to some embodiments.

In operation 208, orchestration system 110 sends precursor instructions 210 to LLM set 260. LLM set 260 includes LLMS 125A-125D as shown, and may be a heterogenous LLM set in which at least two LLMs are different. LLM set 260 may include one or more LLM systems (e.g. 120A, 120B, 120C) and thus may include different computer systems which may be controlled or operated by different entities.

These precursor instructions may relate to particular computational tasks that are to be performed before attempting to perform a simulated evaluation regarding the legal dispute. As just one example, a first subset of precursor instructions 210 may include a computational task for generating a digital evaluator (e.g. a digital mock juror, mock jury panel, mock judge, etc.), while a second subset of precursor instructions 210 may include a computational task for generating jurisdiction-specific information relating to the legal dispute. Operation 208 may include sending particular subsets of instructions to one or more specific LLMs and/or LLM systems. Note that with respect to precursor instructions, the term “subset” refers to a proper mathematical subset; thus, neither the first or second subsets of precursor instructions include the entirety of the precursor instructions.

In operation 213, LLM 125B sends first response data 215 to orchestration system 110. This response data may be based on execution of the first subset of precursor instructions. Likewise, in operation 218, LLM 125C sends second response data 220 to orchestration system 110, which may be based on execution of the second subset of precursor instructions.

In operation 223, orchestration system 110 sends simulation evaluation instructions 225 to LLM set 260. Simulation evaluation instructions 225 may be generated by orchestration system 110 (e.g. based on first and second response data 215 and 220), and include one or more computational tasks for simulated evaluation of a legal dispute (e.g. by a digital evaluator such as a digital mock juror). These instructions may be sent to a single LLM 125 or to multiple LLMs 125, and operation 223 may also include sending proper subsets of simulation evaluation instructions 225 to different LLMs.

In operation 228, orchestration system 110 receives simulated evaluation outcome data 230 from LLM set 260. This simulated evaluation outcome data may be indicative of an outcome of a legal dispute with respect to at least a first party. For example, the simulated evaluation outcome data may include a simulated jury verdict including an outcome such as liable or not liable, guilty or not guilty, as well as simulated damages or sentencing information (e.g. $1.00, $6,500,000, ten years in prison, six months probation, etc.) Note that in instances where a judge, rather than a jury, might determine a portion of the outcome (such as a sentence for a criminal offense), there may be different types of digital personas implemented by LLMs 125 that affect the outcome (e.g. a digital mock judge might be used in addition to a digital mock jury). These operations outlined in FIG. 2 allow computational performance of evaluation tasks (e.g. with respect to evidence & legal issues) in a manner that cannot be done by a human being according to various embodiments, as also discussed elsewhere herein.

FIG. 3 shows one example of a software architecture 300 usable with various structures and techniques herein. Each of the modules shown may comprise computer-executable instructions, and may be stored on one or more non-transitory computer-readable media. Note that the modules may include (or even entirely consist of) computer-executable natural language instructions as may be executed by an LLM that is configured to interpret natural language and generate computational tasks based on that language. In various embodiments, each of the modules may thus include natural language instructions and/or program instructions (e.g. compiled instructions, bytecode, script, or other intermediate form instructions, etc.). The modules may also include or fetch additional data in some embodiments as may be useful for a particular computational task. Different modules may have different configurations in various embodiments. Note that the directional flow arrows in FIG. 3 only indicate one possible configuration of software architecture 300—different flows and different ordering or simultaneous performance of operations may vary. Functionality or aspects of any of the modules in FIG. 3 may be combined with that of another such module according to various embodiments.

Any or all of the functionality described below for the modules in software architecture 300 may be performed by one of LLMs 125. In some instances, a first LLM may be used for execution of one module's functionality, while a second, different LLM is used for execution of another module's functionality. For a particular module, any or all of its functionality may also be performed by two or more LLMs (e.g. in parallel or by having a first LLM perform a first portion of the functionality while a second LLM performs a second, different portion of the functionality). Note that generally, for any and all other modules described herein, such modules may have any or all of the same characteristics as those described above relative to software architecture 300 in FIG. 3.

In some embodiments, any or all portions of modules in FIG. 3 (including dispute evaluator 360) may be stored at orchestration system 110. Thus, system 110 may store natural language instructions, other software instructions, and other data associated with the modules. Prior to run-time, however, orchestration system 110 may instantiate any or all of these modules within one or more LLMs (e.g. LLM set 260). LLM set 260 may then perform execution of various functionality described below. That is, while LLM set 260 may be used to perform particular computing operations (e.g. based on natural language), the instructions and data needed by an LLM may be stored permanently by orchestration system 110. Thus, orchestration system 110 may “set up” each the modules shown in FIG. 3 by providing particular instructions to one or more LLMs. This setup may be done at run-time in connection with a particular legal dispute to be evaluated, or may be done prior, according to various embodiments.

Jurisdiction analyzer module 305 is configured to perform tasks related to a particular location that is relevant to a legal dispute in various embodiments. Note that while some details below are described relative to a jurisdiction for ease of explanation, the functionality described may be applied more generally to any type of location or geographic region for a dispute (and not merely jurisdictions).

Legal dispute resolution may occur relative to a specific jurisdiction. For example, a dispute may be handled in a particular court, such as the U.S. District Court for the Northern District of California, the 194th Criminal District Court in Dallas County, Texas, the U.S. Court of Appeals for the Ninth Circuit, the Oregon Supreme Court, or the Tax Court of New Jersey. A dispute may also be handled by an entity other than a court (which may be governmental or non-governmental) such as the United States International Trade Commission, the Texas Railroad Commission, a mediator, or an arbitration panel. As used herein, the term “jurisdiction” thus may refer not merely to the jurisdiction of a particular court, but to the jurisdiction of any entity that handles a dispute.

When a digitally simulated evaluation of a legal dispute is performed, the relevant jurisdiction may have an impact on the evaluation outcome. As one example, there may be a different outcome for a civil case if it were to be tried in the San Francisco Country Superior Court rather than U.S. District Court for the Northern District of California. Differences between two jurisdictions may drive such outcomes. Jurisdictional parameters that may vary include applicable precedential case law, local court rules, admissibility of evidence, local laws, state or regional laws, national laws, etc. Jurisdiction analyzer module 305 may thus take these factors into account.

Additional factors considered by jurisdiction analyzer module 305 may include tendencies to render a certain type of verdict (or other decision) based on certain kind of case parameters. As one example, consider a “slip and fall” personal injury (PI) case. Across all relevant jurisdictions (e.g. all known jurisdictions in the United States, or all jurisdictions in the state of California), a plaintiff may win a PI case 60% of the time, and lose 40% of the time. Jurisdiction analyzer module 305 may determine such a ratio by analyzing court decisions in the different jurisdictions-by accessing and processing online records in various court databases like PACER, local court database records, third party providers such as LEXISNEXIS™ or WESTLAW™, etc. Such analysis may be carried out through an LLM 125, which may parse records in such data sources, according to an example.

In the slip and fall PI case, assume that jurisdiction analyzer module 305 has determined that in California, Plaintiffs win 60% of the time, but that for a particular jurisdiction in which the injury event occurred, Plaintiffs actually win 80% of the time. Output of jurisdiction analyzer module 305 may thus indicate an 80% “baseline” for winning the case (and/or a 33% greater than the statewide 60% average chance), should it go to a jury trial. A Defendant in a PI case may likewise wish to know if another jurisdiction would offer better chances, and jurisdiction analyzer module 305 may produce output showing that if the Defendant were able to transfer to a second jurisdiction (e.g. a county court in which the Defendant's corporate headquarters reside), Plaintiffs only win 48% of PI cases on average (20% less than the statewide average of 60%, and 40% less than the 80% win rate in the first jurisdiction).

Jurisdiction analyzer module 305 may thus include functionality to analyze and generate a variety of different parameter information corresponding to one or more particular jurisdictions. In some instances, such information may also include evaluator information, such as tendencies or effects of a particular judge on the outcome of a legal dispute. For PI cases heard by Judge A, Plaintiffs may win 60% of the time, but for PI cases heard by Judge B, Plaintiffs may win only 50% of the time. Such information may be determined based on data, and parameterized in order to create a digital evaluation simulation.

Jurisdiction analyzer 305 may also include knowledge of how particular jurisdictional tendencies or jurisdictional rules may affect jury demographics (which may be generated by evaluator features module 310). As one example, it may be the case that in the federal Northern District of California, working mothers with children under 12 years old will almost invariably be excused from jury duty in both civil and criminal cases (e.g. 98% in civil cases and 99% in criminal cases). Thus, even if evaluator feature modules 310 determines that a potential jury pool for N.D. Cal is 8.9% working mothers with young children, the reality is that juries for N.D. Cal will virtually never have such a working mother on a jury panel (perhaps only one or two case trials in 1,000 will include one). When creating an instance of dispute evaluator 360, such considerations may be taken into account.

As another example, assume that for a state court district in New York, the potential jury demographic pool was roughly 5% teachers and other state or federal employees between the ages of 25-55. Jurisdiction analyzer module 305, through record analysis of seated juries in that state court district, may determine that while this juror sub-pool is only 5%, as it turns out such persons historically have made up 12.5% of seated juries (e.g. over a statistically significant sample number). Thus, jurisdiction analyzer module 305 may indicate in its output that potential jurors fitting this profile are 2.5× (250%) likelier to be selected than random chance would indicate. In other words, in various embodiments, jurisdiction analyzer 305 may determine variations between a relevant population demographic and an actual representation of one or more subgroups of the population demographic within juries that were selected. These variations can be used to make a simulated dispute evaluation more accurate and reflective of real-world conditions. (Note that demographics of actual selected juries may be determined by analysis of court records, including jury questionnaires, voir dire transcripts, or other documents).

Jurisdictional analyzer 305 may also determine selection criteria relating to jurisdiction specific rules regarding jury requirements. In a particular state such as Hawaii, for example, it may be the case that people who are age 75 or older are not required to show up for jury duty. Likewise, a jurisdiction may have a rule that a currently enrolled high school or college student is also not required to perform jury duty. Output of jurisdictional analyzer 305 may indicate such facts accordingly, or otherwise adjust its output based on calculated real-world statistics (e.g. perhaps even though not required to show up, about 5% of college students do opt to follow a jury summons).

Demographics module 310 is configured to perform tasks related to dispute evaluator composition as may be relevant to a legal dispute. Demographics module 310 may determine and provide demographic results indicating characteristics that might correspond to a potential juror, judge, arbitrator, mediator, or other evaluator for a dispute. Such generation of demographic results may be based on precursor instructions received by demographics module 310 (e.g. via orchestration system 110).

Demographic results generated by module 310 may vary in form in format. In one embodiment, demographic results include statistical information regarding one or more characteristics of a population associated with a venue. For example:

### DEMOGRAPHIC RESULTS—HARRIS COUNTY, TEXAS

Age Distribution: 18-24 (10.3%), 25-44 (39.7%), 45-64 (32.7%), 65+(17.3%)
Race/Ethnicity: Hispanic/Latino (43.3%), White (non-Hispanic) (27.3%), Black/African American (18.7%), Asian (7.3%), Other races (3.4%)
Gender: Female (50.3%), Male (49.7%)
Education Level: Less than high school (17.7%), High school graduate (24.3%), Some college/associate's degree (28.3%), Bachelor's degree (21.7%), Graduate degree (8.0%)
Political Affiliation: Democratic (52.7%), Republican (41.3%), Independent (6.0%)

Precursor instructions may be executed via module 310 to generate demographic results. Such precursor instructions might include a natural language directive such as “Generate jury pool demographic statistics for eligible potential jurors in Harris County, Texas. Eligible jurors include no felony convictions, no active-duty military, and age 18 or older.” Module 310 may then determine the demographic results according to various techniques, which may include using one or more databases and/or gathering information from networked sources via the internet to compute the demographic results.

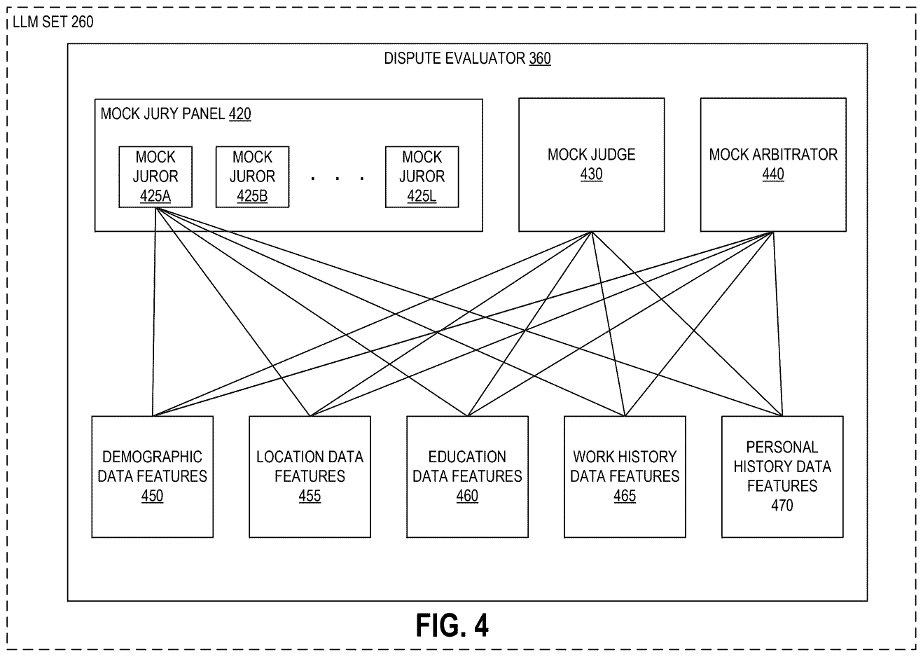

Digital evaluator generator module 315 is configured to perform tasks related to generating digital evaluator persons as may be relevant to legal dispute evaluation. Module 315 thus may function as a “digital juror sample generator” in some embodiments. Output from module 315 may include one or more digital personas that individually or collectively may be used to form dispute evaluator 360. Each of those digital personas may have particular characteristics (e.g. as discussed further below relative to FIG. 4).

Digital evaluator generator module 315 receives output from jurisdiction analyzer module 305 and/or evaluator features module 310 in some embodiments in order to produce digital evaluators such as mock jurors. Module 315 may receive precursor instructions which may include particular parameters, such as a total number of digital jurors to be simulated. Individual mock juror personas may be generated using statistical distributions, for example, corresponding to computing tasks performed by modules 305 and 310 that show sample jury pool statistics as well as venue (location) specific factors that may cause deviations between a local population and the type of population who actually end up serving on a jury.

Dispute evaluator 360 is described in greater detail further below, but is configured to simulate an evaluation of a dispute between two or more parties, such as a legal dispute, according to some embodiments. “Evaluating a dispute”, as used herein, may refer not just to evaluating an ultimate outcome of a dispute, but to any aspect that may affect an ultimate outcome. Thus, evaluating a dispute may include evaluating if a criminal defendant is guilty or not guilty, if a civil defendant is liable for damages owed to a plaintiff, or if a plaintiff is entitled to particular equitable relief (e.g. forcing another party to cease and desist an activity or take a certain action such as tearing down a fence built on someone else's property). But evaluating a dispute may also include determining an amount of importance (qualitative or quantitative) that a particular fact or argument may have-e.g. how much influence a fact or argument may have on an ultimate outcome of a legal dispute.

Case summary module 320 is configured to perform tasks related to summarizing important aspects of a legal dispute in some embodiments. Case summary module 320 may use various information sources in order to produce a case summary, including case documents, applicable law, and legal argument information. Case summary module may retrieve such information from internet sources automatically and/or have such information provided to it by a user (e.g. of client device 105 or system 110). Note that as used herein, the term “user” will refer to a user of client device 105 or orchestration system 110, unless otherwise indicated, but does not preclude the term from applying to a user of a different system.

Case summary module 320 may prepare a case summary based on precursor instructions, which may be received from system 110 and may include execution parameter information, which may be specified by a user. Execution parameter information may be provided to case summary module 320 in order to specify style, appearance, content, and length of a case summary that is produced. Output from case summary module 320 may be in the form of a case summary data structure, which may vary by embodiment, but could be a text file format, a graphics file format, a mixture of the two, or one or more database entries according to a particular database schema. The information in the case summary may include summary information include different sections such as a dispute overview, an outline of a plaintiff's case, an outline of a defendant's case, key facts, disputed facts, key or disputed applicable laws or precedents, or other information. In some embodiments, a case summary may have output parameters specified via instructions (e.g. as received from system 110). Such parameters may relate to length or word count (which may be per section), style, clarity, etc.

In some embodiments, case summary information may be used as an input into a dispute evaluation simulation process (e.g. as performed by evaluation simulation module 340). In such embodiments, accuracy and balance of this case summary information may help produce quality dispute evaluation outputs (as more generally, bad data input may often cause issues with quality of data output). A quality check may thus be performed on the output of case summary module 320.

Quality check module 322, as shown, is thus configured to perform tasks related to ensuring a level of quality for output of case summary module 320. However, quality check module is configured in various embodiments to perform a quality check on any of the outputs of the modules that are shown in FIG. 3. Generalized quality checks for any module may be performed, in some embodiments, by LLM sampling techniques that involve sending functional output back to a set of one or more LLMs (e.g. via quality check instructions issued by system 110). These quality checks may include one or more directives to review LLM output along with a directive relative to a goal of the LLM output. In the case of evaluator features (e.g. demographics) module 310, for example, such a directive might state “Please indicate whether the stated demographic profile for Harris County, Texas, appears to be accurate. Use any available sources of Texas or U.S. demographic data to make your conclusion.” If a threshold level of responding LLMs (e.g. 6 out of 10 LLMs that are polled) indicate that quality levels may not have been met, then an alert may be issued to a user, or other corrective action may be taken.

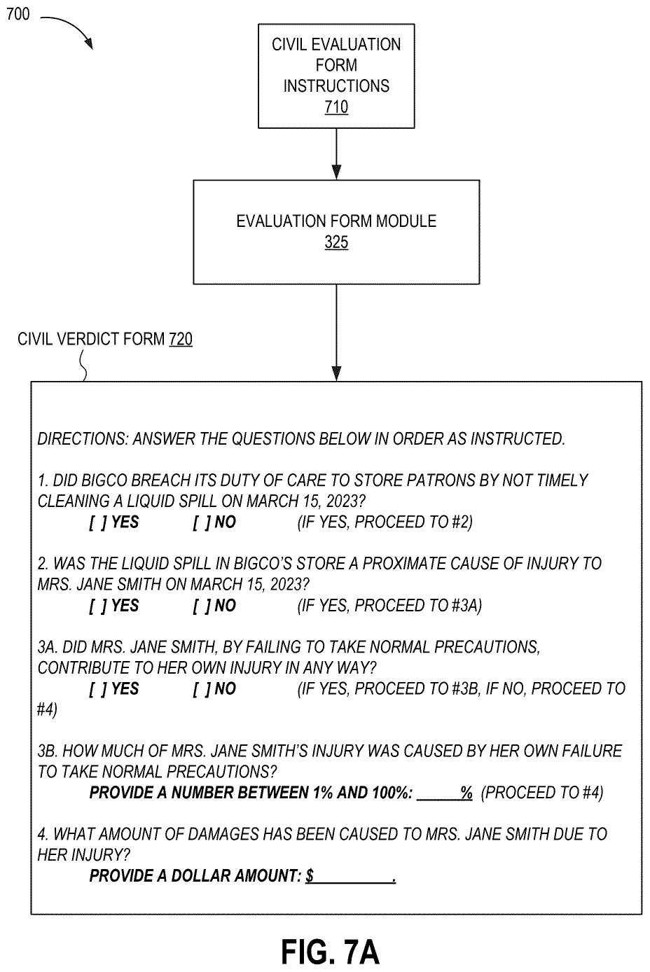

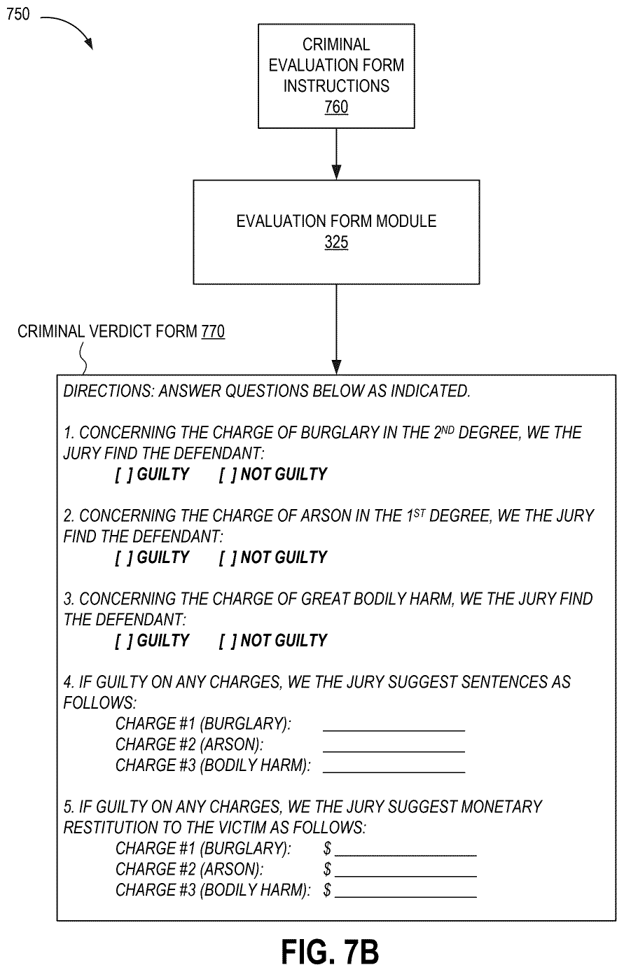

Evaluation form module 325 is configured to perform tasks related to generating a form that is relevant to a framework for evaluating a legal dispute in various embodiments. Module 325 may produce a simulated verdict form in some embodiments, as might be submitted to a jury if a legal dispute were to go to a court trial. In other embodiments, evaluation form module might produce a different type of form (e.g. for a mock judge or mock arbitrator). In many instances, however, forms produced by module 325 may include focused, natural-language questions that relate to key issues or findings of fact or law that are relevant to the legal dispute. As one example, precursor instructions sent to module 325 might include a directive such as “Prepare a sample verdict form for the case Jones v. Smith, with Harris County, Texas, as a venue. Use case documents, a case summary, and available actual trial verdict forms for civil Harris County courts for the last ten years, including District Courts 200, 208, 220, and 226.” In some instances, a verdict form is used by simulation evaluation module 340 in order to simulate a decision making process for an outcome of a legal dispute. Additional detail in regard to verdict forms is provided relative to FIG. 7 as well as elsewhere herein.

Additional questions module 330 is configured to perform tasks related to particular questions that may be posed to a digital evaluator (or individual personas thereof) that are relevant to one or more aspects of a legal dispute. A legal dispute may have many different relevant aspects of varying importance. Module 330 may allow for targeted questions to be directed toward dispute evaluator 360 and for related analysis.

In some embodiments, a user of client device 105 or orchestration system 110 may pose specific additional questions directly themselves. For example, a user might request the following additional questions be asked to individual members of a digital jury panel:
Q1. Will the jury believe that Plaintiff sustained injuries in a “low speed accident”?
Q2. Does the jury think that the property damage photos and dash cam are too minor to support a multimillion-dollar verdict?
Q3. Does the jury think that the property damage photos are too minor to support a serious injury?
Q4. If the judge does not allow into evidence the driver's prior driving while intoxicated (DWI) conviction and commercial driver's license (CDL) revocation (because they were over 10 years before he was hired), what effect will that have on the liability decision?

Such additional questions may result in detailed analysis when simulation evaluation results and corresponding reporting outcome information are generated. The reporting information may indicate a qualitative or quantitative effect (e.g. small difference, big difference, 76% difference) for various aspects related to the additional questions. This can give important insight into what may matter the most at a trial, and what may be less important. Additionally, the present techniques may also interface with juror demographics (as discussed elsewhere herein) to provide breakdowns of differences in impact for different potential juror segments. Relative to additional question #4, for example, reporting outcome information may indicate that:
The exclusion of driver's prior DWI and CDL revocation would reduce findings of Defendant's negligence from 91% to 84% of jurors.
Older jurors (65+) showed greatest reduction in company liability findings (14% decrease).
College-educated jurors were most influenced by the exclusion (12% decrease).
White jurors showed largest reduction in company liability findings (13% decrease).
Republican-leaning jurors were most affected by evidence exclusion (15% decrease).

In other embodiments, orchestration system 110 may automatically generate or modify follow-up questions based on input provided by a user. For example, a user might provide a natural language directive to system 110 such as “I really want to know which evidence on both sides is going to be the most persuasive, and how hard we should fight to include or exclude certain evidence.” System 110 may then automatically determine additional questions to be created based on such user input, by reviewing case documents, a case summary, or other information. System 110 may then determine and generate additional questions automatically without human intervention, such as:
Q1. How much likelier is acquittal if the knife is excluded?
Q2. Can the eyewitness testimony be discredited by an expert witness who describes how eyesight and memory may be faulty, especially when the eyewitness was 82 years old and was first questioned by police one week after the alleged crime?
Q3. How damaging is the Defendant's statement, made to police upon his arrest, that “Oh yeah, I know why you guys are here for me.”

In addition to the above, there may also be embodiments where orchestration system 110 automatically determines a list of one or more potential additional questions that may then be edited or pruned by a human user (e.g. of client device 105 or orchestration system 110).

Evaluation simulation module 340 is configured to perform tasks related to a simulated evaluation process that is relevant to an outcome for a legal dispute in various embodiments. Module 340 may receive as inputs, in some embodiments, any or all of the outputs produced by other modules in FIG. 3, as well as instructions as may be received from orchestration system 110, for example. Evaluation simulation module 340 may utilize dispute evaluator 360 (e.g. an instance of one or more mock jurors or other digital evaluator personas) in order to perform simulated dispute evaluation.

Module 340 may produce output information that indicates one or more simulation results relative to a decision making process for a legal dispute. In some instances, a case summary and a verdict form are used as source material or to establish parameters for the dispute evaluation simulation, in addition to any other parameters for simulated evaluation (e.g. as may be specified user or received from orchestration system 110). Output of module 340 may include answers to specific questions, findings of specific fact, indications of reasoning for decisioning, and numerous other types of information relative to any or all digital evaluator personas that may comprise dispute evaluator 360. Thus, in one embodiment, each member of one or more digital mock jury panels may have corresponding particular output information within the output of module 340. Output information from module 340 may thus include data characteristics for digital evaluator personas as well-thus, output might include demographic information for a digital mock juror, as well as specific evidence they found compelling in reaching a decision, evidence they did not find compelling, and other information that provides insight into the decision making process. Additional details regarding simulated dispute evaluation processes are provided elsewhere herein.

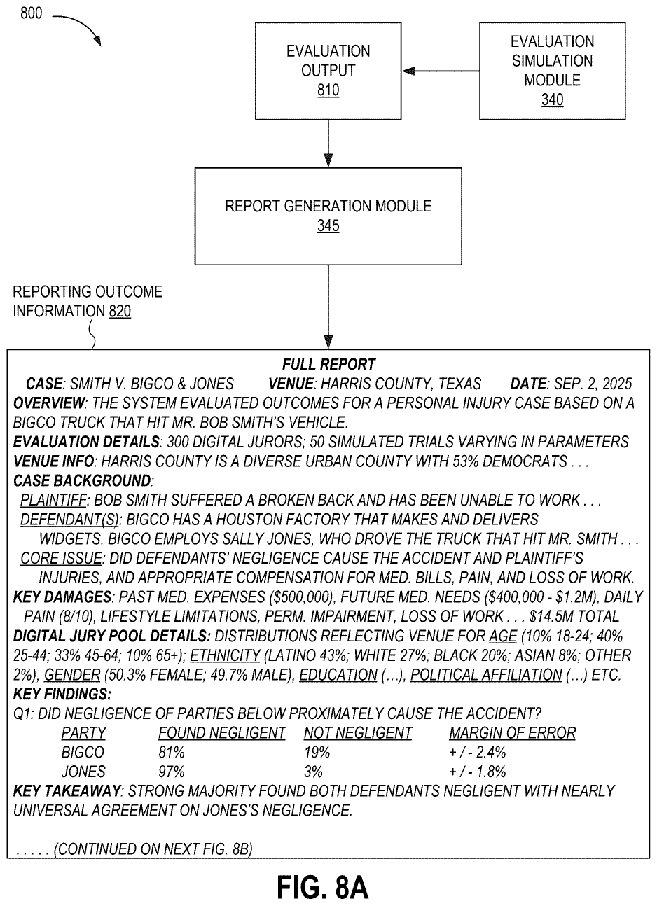

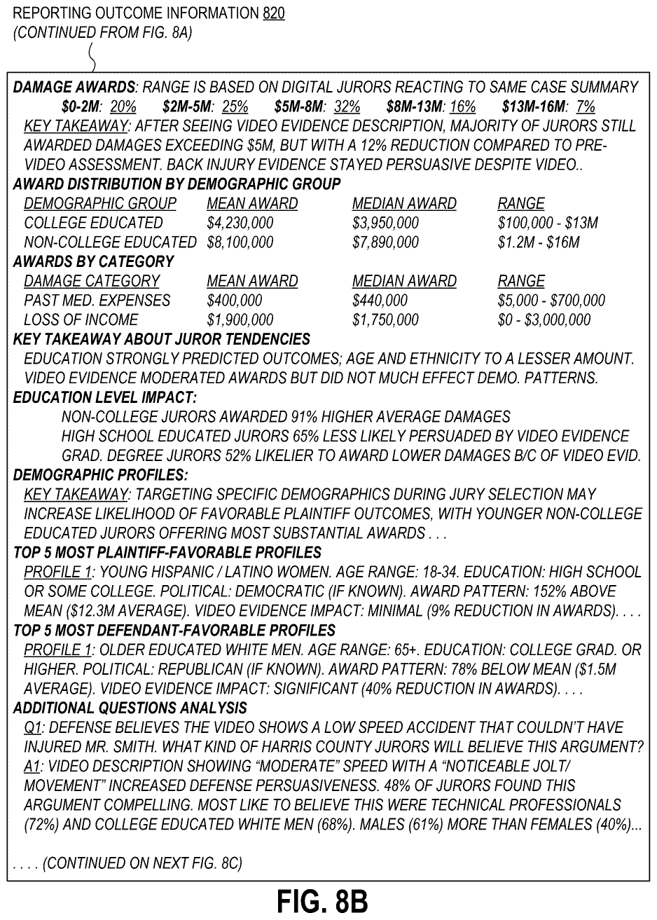

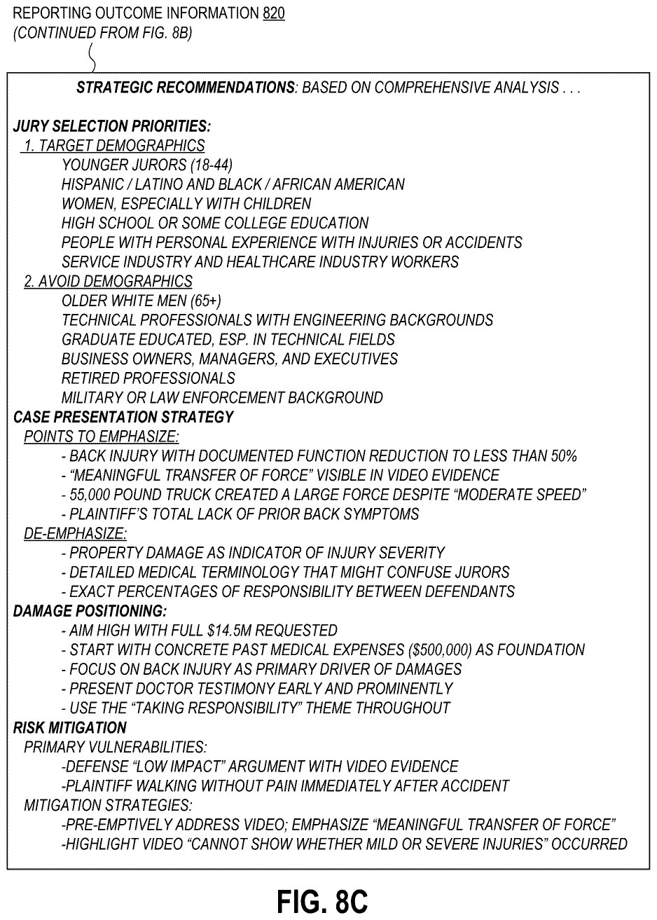

Report generation module 345 is configured to perform tasks related to generating reporting outcome information that is relevant to an outcome of a legal dispute in various embodiments. This module may receive an output from evaluation simulation module 340, and process the output into a particular format (e.g. as may be easily understood by a user). Module 345 may receive instructions from orchestration system 110 and accompanying specified parameters regarding content of reporting outcome information. More detail is presented in this regard with respect to FIGS. 8A-8C and elsewhere herein.

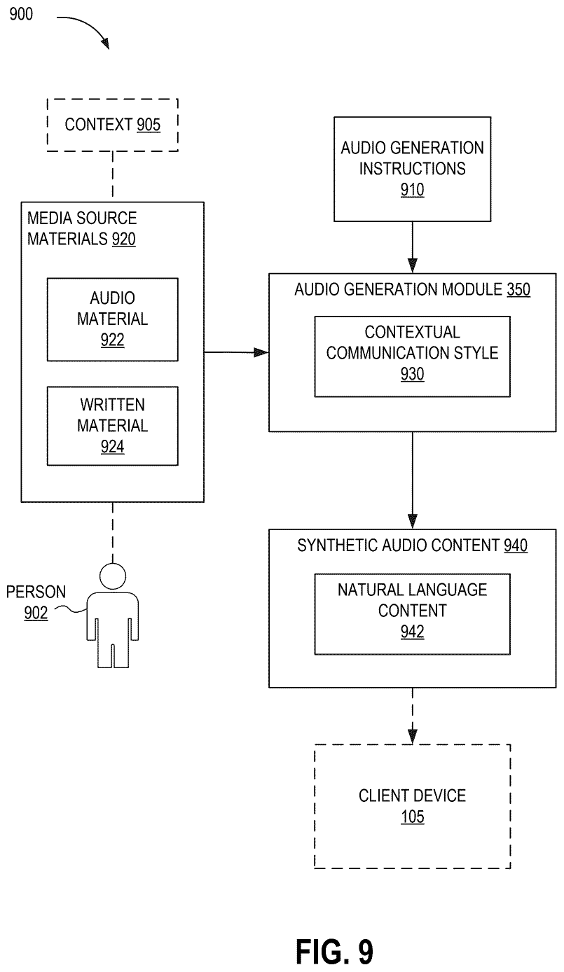

Audio generation module 350 is configured to perform tasks related to generating synthetic audio content that is relevant to a legal dispute in various embodiments. Module 350 may receive inputs including reporting outcome information from module 345 and instructions and accompanying parameter information (e.g. from system 110). In one embodiment, audio generation module 350 may produce an audio summary that includes information regarding a simulated evaluation process (e.g. as may be performed by dispute evaluator 360 in conjunction with evaluation simulation module 340). In a further embodiment, this audio content may be specifically stylized to match a voice and speaking style of a particular individual. More detail in this regard is described relative to FIG. 9 and elsewhere herein.

Turning to FIG. 4, a diagram is shown of one example of a dispute evaluator and associated components as may be used in the context of simulation evaluation in an LLM architecture. As shown, dispute evaluator 360 is contained within LLM set 260. Thus, one or more of LLMs 125 may be used to implement dispute evaluator 360, which may be executable software instructions and/or associated data. Dispute evaluator 360 may be implemented via instructions sent to LLM set 260, which may include natural language instructions. Dispute evaluator 360 may stored outside of LLM set 260 in embodiments, however (for example, all information usable to establish and/or execute computing tasks via dispute evaluator 360 may be stored on orchestration system 110).

Dispute evaluator 360 is configured to simulate an evaluation of a dispute between two or more parties, such as a legal dispute, according to some embodiments. Evaluator 360 may include one or more of a mock jury panel 420, mock judge 430, or mock arbitrator 440. These constructs may likewise be executable software instructions and/or associated data, and may have simulated personas with particular data features (i.e. characteristics) as further described below. While panel 420, judge 430, and arbitrator 440 are all shown in FIG. 4, it may be the case that only a single one of these will be present within an instance of dispute evaluator 360. Further, the configuration of dispute evaluator 360 may differ than what is shown (for example mock arbitrator 440 may include a panel of multiple mock arbitrator individual personas similar in any or all aspects to the mock jurors shown).

An advantage of the dispute evaluator 360 over humans-and limits that it has beyond what can be accomplished in the human mind, even with pen and paper-is that dispute evaluator 360 can be programmed to evaluate disputes as a tabula rasa (blank slate). This may be particularly useful when attempting to evaluate a dispute by using variations (on evidence, argument, legal posture, etc.) to see what parts of a case may be strongest and which may be weakest. Unlike a human mind, dispute evaluator 360 may give a “first impression” on countless possible variations for a dispute. A human, however, cannot during a second dispute evaluation simply pretend to have never heard of a piece of damning evidence that was aired during an initial, first dispute evaluation.

Mock jury panel 420, as depicted, includes 12 mock jurors (with only 425A, 425B, and 425L shown). Each mock juror may be programmed (e.g. via instructions sent by orchestration system 110) according to certain parameters as may be desired by a user. These parameters may be reflected within the data features shown in FIG. 4. Each of these data features may take the form of stored information and/or executable instructions (which may be included in any of instructions 210 or 225 in some embodiments and thus conveyed to LLM set 260). In some embodiments, some or all portions of one or more of these data features may be programmed according to outputs of one or more of the modules described relative to FIG. 3. Thus, in one embodiment, evaluator features module 310 may produce demographic data features 450, location data features 455, etc. Many various combinations of such data features may be used in different embodiments, and there may be additional data features to those specifically described below.

Demographic data features 450 include data regarding an evaluator persona such as their age, race or ethnic background, height, weight, gender, income information (e.g. income range such as less than $30,000 per year, between $30,000 and $50,000, etc., or income quintile for their area), relationship status (married, single, divorced, etc.), residential status (homeowner, renter, live with parents, unhoused, etc.). Location data features 455 may include any and all location-related data about a persona for evaluator 360. This may include their current city, state or province, street address or postal code, region of state or country (e.g. south Texas, northwestern Canada) as well as such information for different stages of life (e.g. grew up until age 15 in Florida, moved to Los Angeles and lived there until present day, etc.) Education data features 460 may include information such as highest level of education (did or did not graduate high school, some college, college and degree and what type of degree, professional degree, etc.). Work history data features 465 may include different jobs held as well as titles and descriptions, type of work (manual labor, professional, etc.), length of tenure, whether promotions or firings occurred, etc. Personal history data features 470 may include any number of characteristics about likes, dislikes, tendencies, and other data about a (simulated) person. This could include dietary preferences, religious affiliations, arrest or incarceration record, tax delinquency status, registered voter status, political party affiliation, etc.

Note that in some disputes, not all data feature information described above may necessarily be available or relevant in particular real-world situations. Depending on the nature of a dispute and its particular facts and issues, however, various items of the information above may be something that a juror could be asked about in a voir dire (jury selection) setting, for example. The fact that such data features can be specified for individual personas in dispute evaluator 360 is another advantage of the present techniques over human-directed mock jury techniques. Logistically, for example, it may be too difficult and take too much time to obtain all such data feature information about individuals on a human mock jury—or humans on the mock jury may be reluctant or unwilling to share certain information about themselves (or even deceptive about such information) that they consider too personal. But such data feature parameters about individual characteristics can be set up with ease within dispute evaluator 360, according to some embodiments.

As with many aspects of the present disclosure, different LLMs within LLM set 260 may optionally be used to generate each persona (e.g. a juror, judge, or arbitrator) within dispute evaluator 360. Based on performance monitoring, for example, it may be the case that one type of LLM performs better than another at generating certain types of evaluator personas (e.g. one LLM might do better at modeling male-gendered mock jurors, while another does better at modeling female-gendered mock jurors). Thus, LLM 125A might be used to generate mock juror 425A while LLM 125C might be used to generate mock juror 425L. Such generation may vary based on instructions sent to LLM set 260. The configuration of evaluator 360 may also vary. For a criminal trial, mock jury panel 420 may be configured to have 12 jurors, while for a civil trial it may be configured for 6 jurors. In addition to applicable data features 450-470, mock judge 430 may also be configured according to particular judicial bench history data features (e.g. prior case decisions include trial verdict decision, damages, criminal sentence, mistrial frequency, etc.) according to some embodiments. Mock arbitrator 440 may likewise be configured based on applicable data features 450-470 as well as arbitration outcome history and other information (e.g. trade group associations etc.).

Digital evaluators within dispute evaluator 360, such as mock jurors 425A-425L, may also be configured to communicate with one another as part of a dispute evaluation process, similarly to what may occur in actual human jury deliberations. Digital mock jurors may each be configured as a separate, self-contained instance that will not only evaluate input about a legal dispute (e.g. evidence, arguments), but will convey its evaluation viewpoints to one or more other digital mock jurors. Dispute evaluator 360 may thus simulate live conversation between jurors about a dispute. This conversation may include textual output from one or more mock jurors regarding different aspects of a dispute. As one example, mock juror 425A may output the natural language phrase “I think everyone else may be forgetting that BigCo hired an unlicensed driver to drive their truck—that seems incredibly negligent!” Others of mock jurors 425B-425L may parse this output of mock juror 425A, and use it to consider their own final evaluation regarding one or more dispute aspects. Such conversational outputs may be generated by or stored by one or more LLMs 125 during or after a dispute evaluation process.

Weighting of conversational outputs by mock jurors (or other digital evaluator personas) may vary according to different embodiments. Weighting rules may be specified (e.g. by orchestration system 110) in regard to conversation. For example, conversational output directed to one or more specific mock jurors may be more heavily weighted by the mock jurors being directly addressed, but still receiving some weighting by other mock jurors not directly addressed. Thus, mock juror 425B may have a conversational output of “Hey 425A, you say we know that the gun belongs to the defendant, but we don't. All we know is the gun was a 0.40 caliber weapon and the defendant also owned a 0.40 caliber weapon.” In this case, mock juror 425A may give this conversational output of mock juror 425B a relative (arbitrarily scaled) weighting of 1.5, while other mock jurors may give the conversational output a relative weighting of 0.75. Conversational weightings may also be randomized according to standard or other distributions in some embodiments (e.g. each mock juror will give a relative weighting of 1.0 to any conversational output of any other mock juror, randomized according to a standard deviation of 0.5, such that when randomization gives a value of −2 or greater standard deviations, the conversational output will be given a relative weighting of 0 (1.0 −0.5 −0.5), while a randomization value of +2 or greater standard deviations will result in a relative weighting of 2.0 (1.0+0.5+0.5), where 0 might be a minimum weighting value and 2.0 is a maximum weighting value. Conversational outputs and inter-mock juror communication may be conducted according to a predetermined or dynamically generated maximum quantity of outputs per mock juror, maximum quantity of all total mock juror outputs, or some other mechanism to ensure that a final determination is reached regarding an aspect of a legal dispute.

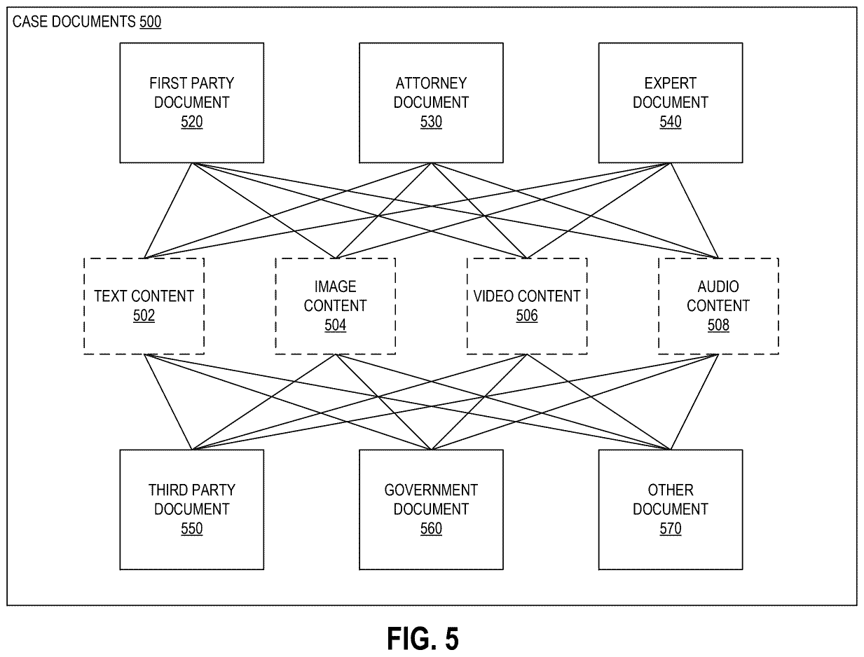

FIG. 5 illustrates an example of case documents 500 as may be used in relation to simulating an outcome of a legal dispute. Note that the documents and types of content shown in this figure do not preclude additional documents or content types from being present in other embodiments. Additionally, the term “document” as used herein is intended to be broadly construed, and does not simply refer to pages of paper or digital representations thereof, for example. Instead, document may refer to digitized information in a variety of forms, as discussed below. Case documents 500 may include actual or potential evidence that is admissible in a court trial, but may also include documents that are not or would likely not be admissible as evidence.

Case documents 500 may include a variety of different content types. These include text content 502, image content 504, video content 506, and audio content 508. Any of the example documents described may include any content type or a mixture thereof. Multiple instances of each of the example documents shown may also exist-there may be numerous first party documents 520, for example. Thus, one first party document 520 might include only text content 502, while another first party document 520 might include image content 504 as well as audio content 508. In some disputes, one or more documents also may not exist (in a two-party civil divorce case, there may be no instances of expert document 540 or government document 560, as just one example). Each instance of a case document 500 may have one or more corresponding digital storage mechanisms (e.g. one or more

Text content 502 is a broad category that includes natural language textual content or numeric content, but also may include content in another form. Text content 502 may thus include letters, notes, reports, transcripts, and other such documents written in English, Spanish, Mandarin, or another natural language. Text content 502 may include electronic conversions of physical documents made via optical character recognition (OCR).

Other forms of text content 502 may include data that is partially or even wholly not in natural language form. Text content 502 may thus include computer source code, script code, intermediate code, or compiled code. Text content 502 may include data and/or metadata, and thus could include one or more data log entries or database entries—a portion of which might could natural language or numeric data as part of the entry, and other portions of which might contain metadata such as time(s) of last access, security or access restrictions on that database entry, etc. Text content 502 may include a variety of computerized digital file formats (e.g. PDF, MS Word, spreadsheet file, database file, etc.) Text content 502 is not limited to the examples described above, however.

Image content 504 includes visual content such as pictures, drawings, sketches, or charts. Such content may be difficult or impossible to represent as text content 502, in some instances. Image content 504 may thus include still images, such as a digital image having a JPEG, TIFF, PNG, or GIF format. In some instances, image content 504 may include an animated image (e.g. an animated image as may be permitted by the GIF format). As noted above, any of case documents 500 may include more than one content type—thus a case document that is stored in an electronic file format might have text content 502 within it, but also include an embedded JPEG image.

Video content 506 may include moving visual content, i.e., a movie. Video content may thus include content that is encoded for playback according to the MPEG4, MOV, AVI, or WMV standard. Video content 506 may include a digitization of analog video content (such as a videocassette tape recording). Video content 506 may also include an audio component in some instances, and the separate depiction of audio content 508 in FIG. 5 is not intended to imply that video content 506 necessarily lacks any sound (though this may be the case in some instances, such as some types of security camera footage).

Audio content 508 includes audible content, and may be encoded for playback according to a variety of standards, including MPEG3, M4A, FLAC, AAC, WAV, or OGG. Audio content 508 may also include a digitization of analog video content (such as a magnetic audio tape cassette). In various embodiments, audio content 508 does not include an associated video component and may be purely audible without a visual aspect.

First party document 520 is a document associated directly with one of the parties involved in a dispute, according to some embodiments. First party document 520 may thus be an email, text message, or physical letter that was authored by a party in a lawsuit or by someone else associated with that party, such as an employee or officer of a corporation. First party document 520 may also be a deposition record of a party (or someone associated with that party. First party document 520 may be an audio recording of an interrogation conducted between the police and a person being prosecuted (or facing potential prosecution) for a criminal offence. In this police interrogation example, the same underlying digital information (e.g. digital file) may be categorized as both a first party document 520 as well as a government document 560. Thus, there may be various instances where the same digital file may qualify as two or more types of case document 500. The illustration in FIG. 5 of case documents 500 is thus not intended to imply that any of the document categories are mutually exclusive with any other.

Attorney document 530 is a document associated with an attorney who is or may be involved with a legal dispute, such as by representing a party in the dispute. Attorney document 530 may thus include a demand letter or a cease-and-desist letter. Attorney document 530 may include case notes, statutory or regulatory analysis, attorney opinion, or advice and counsel. In some embodiments, information that is protected by an attorney-client privilege may not be included in an instance of attorney document 530. In other embodiments, privileged information may be included within an instance of attorney document 530 (for example, a user of orchestration system 110 may voluntarily wish to provide attorney notes for use in dispute evaluation, even if such information might not ordinarily be admissible in a courtroom setting).

Expert document 540 is a document associated with an expert who is or may be involved with a legal dispute. An expert witness who has been retained by a party may often be the source of expert documents 540, which therefore may include an expert witness report. Such a report may offer an expert opinion on one or more disputed matters of fact that are relevant to a possible outcome of a legal dispute. Instances of expert document 540 may also include material other than an expert witness report however, such as a deposition record, scientific paper, book, newspaper or magazine article, description of expert credentials, résumé or curriculum vitae, undergraduate or graduate degrees awarded, or court testimony transcript, for example.

Third party document 550 is a broad category of documents associated with a party who is not necessarily involved in a legal dispute, according to some embodiments. A third-party document 550 could be a witness statement from a bystander who saw events relevant to a criminal or civil case, or could be a video or audio recording of those events that was taken by the bystander. Third party document 550 could be security camera footage, a copy of an insurance policy that covers a party in a dispute, or a reference work such as a textbook, encyclopedia, or dictionary.

Government document 560 is a document associated with a governmental authority such as the police, a regulatory or advisory body, a prosecutor's office, legislature, or a court, according to some embodiments. Government 560 may thus encompass a broad range of documents, such as a record of an infraction and fine issued by the Occupational Safety and Health Administration, a traffic citation issued by a local police agency, a warrant used to execute a search or seizure, an arrest report, an interrogation record, criminal history record, a legal statute and/or associated legislative notes and comments, or a bill of indictment. Many other types of government document are possible and contemplated.

Other document 570 may be any other type of document that does not fall into one of the other categories already discussed above (though again, these categories are not necessarily exclusive of one another). Dispute evaluator 360 is configured in various embodiments to use all manner of source documents and content types in evaluating possible outcomes for a dispute, and merely because a specific type of document or content was not mentioned above does not imply case documents 500 or dispute evaluator 360 are limited to the examples above.

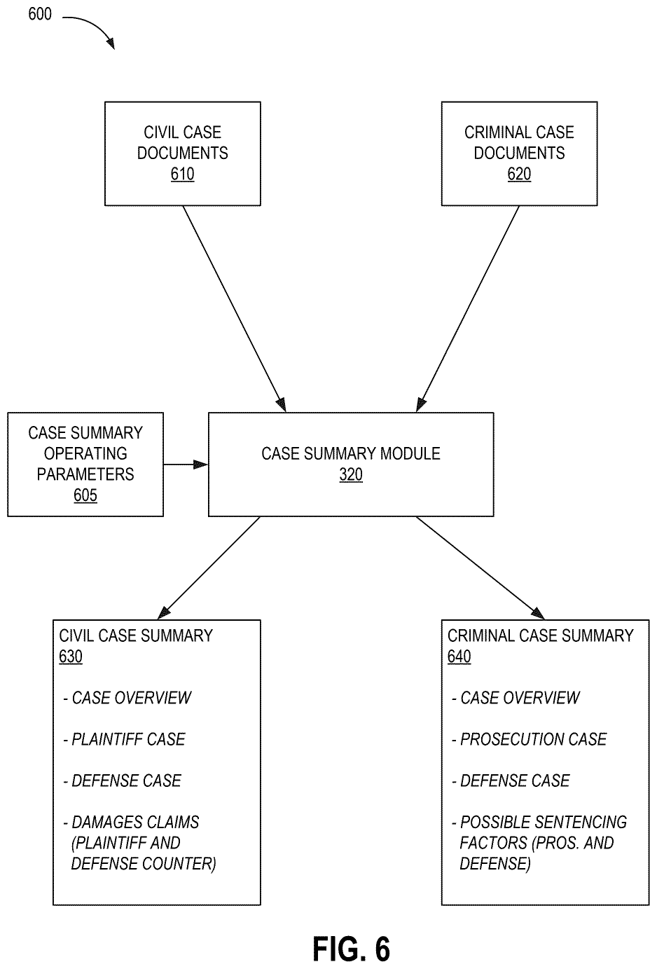

FIG. 6 is an example 600 illustrating a flow of certain operations of case summary module 320, according to some embodiments. In this example, case summary module 320 is configured to receive civil case documents 610 and criminal case documents 620. These documents may have any of the aspects of case documents 500 as described above.

Case summary module 320 is configured to analyze civil case documents 610 and then produce a civil case summary 630. In some embodiments, summary 630 includes natural language text output which may appear in one or more of a variety of formats (e.g. narrative sentences, bullet points/highlights, headings, table of contents, etc.). Summary 630 may also include image or video content in some embodiments. In additional embodiments, summary 630 may also include audio content. The length, specificity of detail, and type of content appearing in civil case summary 630 may vary according to case summary operating parameters 605 provided to case summary module 320 (as may be provided by orchestration system 110 or another system, e.g. in the form of evaluation precursor instructions). Case summaries may vary widely in content and form, according to various embodiments.

Civil case summary 630 may include various sections such as a case overview, plaintiff's summary, defendant's summary, and a damages claims section. The case overview may provide a high-level overview of a case, such as “Mrs. Jane Smith is suing RealBigCompany, Inc., for negligence causing her bodily harm due to a fall that occurred in a RealBigCompany store on Mar. 15, 2023, and is asking for $500,000 in damages.” Such case overviews may be more detailed than this brief example, however.

A plaintiff's summary or defendant's summary may provide an overview of key points and/or evidentiary basis for the legal position of the plaintiff or defendant. Such a plaintiff's summary may include language such as “On March 15, Mrs. Smith fell and broke her hip in BigCo's store in St. Louis, MO. She incurred $400,000 in medical bills and lost $100,000 in income due to her injuries. BigCo is liable for these injuries because eyewitness testimony indicates Mrs. Smith slipped in a puddle of water that sat in the middle of an aisle for at least 2 hours without being cleaned up. This failure to act by BigCo meets the requirements for negligence, as laid out in the Missouri Supreme Court case Johnson v. Smuckers (1967).” Again, such a summary (as well as other examples) may be more detailed than a simplified version given herein for purposes of explanation.

A defendant's summary may include language such as “BigCo has no liability for Mrs. Smith's fall. Evidence will show that she likely engineered her own injuries. Court records indicate that she has sued 12 times in 10 years for slip and fall accidents at other stores in Missouri. Our expert will testify that the odds of this happening by pure chance are less than 0.2%.” Note also that in disputes with multiple plaintiffs or multiple defendants, such sections may be broken down further into differentiations that correspond to each plaintiff or defendant (or groups of such whose particular summaries are similar).

Civil case summary 630 may also include a damages claims section, which may be broken down into plaintiff claims and defense counters. An overview of plaintiff damages theories and supporting evidence may be provided in this section, and likewise for defendant's damage mitigation theories. Continuing the example above, the defendant's damage summary might include statements such as “Even if BigCo was liable, Mrs. Smith's damages are no more than $50,000. Evidence shows that her injuries were treated by her cousin at a greatly inflated cost, and she has no lost income because she has been unemployed for 6 years.” In some embodiments, civil case summary may also include other information on remedies besides monetary damages (e.g. equitable remedies).

Criminal case summary 640 may be produced by case summary module 320 based on criminal case documents 620, and may be similar to the civil case summary in many aspects. However, particulars may vary based on government prosecutor allegations and evidence and defense strategies regarding undermining such allegations and evidence. In some embodiments, criminal case summary 640 may include a section on possible sentencing factors rather than damages as in a civil case. Such sentencing factors may only be relevant in the event a defendant is found guilty, however.

FIGS. 7A and 7B illustrate examples 700 and 750 regarding flows of certain operations of evaluation form module 325, according to some embodiments. In FIG. 7A, evaluation form module 325 receives civil evaluation form instructions 710 (e.g. from orchestration system 110). These instructions may be received as part of precursor instructions sent to LLM set 260 and may include various parameters. Note that while not depicted, evaluation form module 325 may also receive or have access to additional information besides instructions 760 in some embodiments (e.g. case documents, jurisdiction information, etc., or any other such information). Evaluation form module may then produce an evaluation form according to instructions and/or additional information. Civil verdict form 720 is one example of an evaluation form that may be produced by evaluation form module 325, and includes natural language questions and instructions as might be given to a jury if a civil dispute were to go to a court trial. Many different variations of an evaluation form produced by evaluation form module 325 are possible and contemplated, and may depend on specific evidence, questions of fact, or questions of law relating to a particular legal dispute. FIG. 7B illustrates another example of an evaluation form that may be produced by evaluation form module 325. In this example, criminal evaluation form instructions are provided to evaluation form module 325, which may then produce criminal verdict form 770 as output. Aspects described above relative to FIG. 7A are also applicable to the example of FIG. 7B in various embodiments.

FIGS. 8A, 8B, and 8C illustrate an example 800 regarding flows of certain operations of report generation module 345, according to some embodiments. In this example, report generation module 345 may receive evaluation output 810, which may be produced via evaluation simulation module 340 (e.g. based on certain instructions sent to an LLM and/or to LLM set 260). Evaluation output 810 may include various output content relating to one or more simulated evaluations for an outcome of a dispute, and may indicate simulated decisions such as might be made by a jury, judge, or arbiter (which may be an arbitration panel). When multiple simulated individuals are involved in these simulated decisions, output 810 may include individual decisions (e.g. from specific mock jurors) as well as a collective decision (e.g. from a mock jury panel comprised of 12 mock jurors). Evaluation output 810 may include a large volume of information related to any or all aspects of a legal dispute (e.g. case documents, party information, etc.), including any or all aspects relating to the simulated evaluation process itself (e.g. demographics of mock jurors or other digital evaluator personas, verdict outcomes, applicable case law, admissibility of certain evidence, etc.) While not depicted, report generation instructions may also be given as input to report generation module 345 (e.g. by system 110). Such instructions may include various parameters affecting length, detail, presentation style, and particular reporting information to be generated. These instructions may include specifics given by a user of client device 105 in some cases.

Reporting outcome information 820 may be produced by report generation module 345 based upon its inputs, and an example of this reporting outcome information is shown across FIGS. 8A-8C . The reporting outcome information 820 that is shown on these figures is merely one example of the many different formats and types of information may appear in the content of information 820. Graphical, audio, or video content may be included in information 820 in some embodiments (e.g. a key piece of video evidence or an audio case document could be included). More generally, any information or instructions created or used by any of the modules in FIG. 3, or modifications thereof, may be present in reporting outcome information 820

Reporting outcome information 820, as shown, includes dispute specifics such as venue, parties, cause of action, and requested damages Reporting outcome information 820, as shown, also includes a background summary, information about a simulated dispute evaluation process, evaluator (mock jury) demographics, venue demographics, and outcome of the dispute (e.g. liability, damages). Reporting outcome information 820, as shown, further includes insights, suggested strategies, and highlights factors that may have had a key influence in an outcome of the dispute. Note that while example 800 relates to a civil case, reporting outcome information 820 may correspond to a criminal legal dispute in some embodiments, and specific content appearing in reporting outcome information 820 may vary accordingly.

FIG. 9 illustrates an example 900 regarding flows of certain operations of audio generation module 350, according to some embodiments. Audio generation module 350 may receive audio generation instructions 910 (e.g. via system 110). Such instructions may contain parameters as to style and content that should appear within synthetic audio content 940. Input to audio generation module 350 may include reporting outcome information 820 or evaluation output 810 according to various embodiments, and such input may be used as a basis for operations described herein.

Audio generation module 350 is configured to produce synthetic audio content 940 in a particular contextual communication style 930 in the embodiment shown. Communication style 930 may correspond to a specific human person 902—e.g. to mimic the type of communication that might be made by a real person (living or dead) when conveying certain content. Such content may include one or more aspects related to a dispute, but the presently described audio techniques are not limited only to legal disputes. These techniques may also be applied more generally, and can be used relative to any situation in which audio content in a particular personal style may be desirable. In one embodiment, person 902 (whose style may be simulated) is an accomplished member of the legal field with deep insight and understanding into jury trials, judicial trials, and arbitration processes. In other embodiments, person 902 may be a celebrity, an author, a professor, an artist, a family member of a user of client device 105, or any other individual.

Audio generation module 350 may create a contextual communication style 930 based on media source materials 920 that correspond to person 902. Contextual communication style 930 may be based not just on person 902, but also a communication context 905 relating to the synthetic audio content 940 that is to be generated. Context 905 may be a category such as communication on, about, or significantly containing content related to one or more specific topics—such as legal disputes, jury trials, and/or mock jury trials. Context 905 may be a category related to any other specific topic, and is not limited as such. Context 905 therefore may be content related to cooking, playing or learning a musical instrument, political analysis, or limitless other topics.

Context 905 may also include a target listener, or type of target listener. When humans speak, their speech (content, tone, inflection, choice of phrasing, etc.) may vary significantly depending on to whom they are speaking. As one example, a 45 year old female may speak differently to her five year old son at home than how she speaks to her 50 year old manager at work or to her 78 year old mother. A target listener in context 905 may be as specific as another particular human person or may be one or more categories of varying breadth of other human persons. In one embodiment, the type of target listener in context 905 is an attorney or a party involved in a legal dispute, though many different target listeners or types of target listeners are possible. In other embodiments, the type of target listener in context 905 may be more specifically tailored to demographic characteristics: for example, an attorney who has no background in engineering but is involved in a legal dispute involving deeply technical aspects such as a patent litigation lawsuit. Or a target listener may be a party involved in a legal dispute who has a certain level of education (e.g. has not graduated from high school, has graduated college, or has an advanced degree).

Media source materials 920 may include, but are not limited to, audio material 922 and written material 924. Audio material 922 may include any recording of audio (e.g. speech) that was uttered by person 902. Accordingly, audio material 922 may include recorded public speeches, recorded private speech, dictation, interviews, films, podcasts, or music (though is not limited to such examples). Written material 924 may include any written content that was authored at least in part by person 902, and thus may include books, emails, articles, academic papers, court decisions, text messages, letters, notes, etc. (though is not limited to such examples). In some embodiments, at least one audio material 922 is used to generate communication style 930, but a written material 924 may not be used.

Each instance of media source materials 920 may also have one or more associated contexts (e.g. context 905), which may be in the form of metadata corresponding to a digitization of a particular media source material. A recorded public speech, for example, might have contexts that include topics and/or target listeners such as “jury trials; criminal trials; strategies on mitigating difficult evidence at trial; target audience of attorneys and judges of any age.” A recorded private speech might have contexts that include topics and/or target listeners such as “learning piano; beginner piano techniques; piano finger placement; target audience of children aged 6-14.”

Contextual communication style 930 may thus be generated based on media source materials 920 as well as one or more contexts associated with those materials. In some instances, a media source material that does not relate to a particular context may be ignored when module 350 generates style 930, or may be given a lesser weight. Contextual communication style 930 may thus function as a communication blueprint that corresponds to how person 902 speaks on a particular topic or to a target listener.

Technical audio characteristics associated with audio material 922 may also be used to generate contextual communication style 930. These audio characteristics may include specifics as to tone, pitch, inflection, accent, spacing or pauses between different sounds, and sounds made when uttering particular letters, syllables, words, phrases, or non-verbal noises. Sound waveform analysis techniques may be combined with textual transcriptions of speech to formulate specific rules or data characteristics that effectively parameterize the speech patterns, phrasings, and choice of words associated with contextual communication style 930 of person 902.

An LLM 125 may be used to generate contextual communication style 930 based on instruction parameters, according to various embodiments. One example of such an instruction in natural language form might be “Create a communication style that sounds like attorney F. Lee Bailey when he speaks about trial strategy. Use any available recorded audio of F. Lee Bailey's voice from the last 50 years to mimic his tone, speech patterns, phrasing, choice of words, use of slang or jargon, accent, and anything else in his speaking to sound as close to him as possible. Attempt to use recorded audio that specifically talks about criminal defense strategy, jury selection, or trial strategy more generally. Give heavy weight to any recorded audio that appears to be targeted to other attorneys, and less weight to television or media appearances addressed to the general public.”

Synthetic audio content 940 may thus be generated (e.g. also by an LLM 125 in some embodiments) based on both the specifics that relate to a legal dispute as well as a contextual communication style corresponding to a particular person. The resulting audio content may not just sound like person 902, but effectively simulate the phrasing, words, and sentences that person 902 would use to convey information to a target listener. Synthetic audio content 940 may thus include natural language content 942 that has words and sentences that correspond with the way that person 902 actually speaks (or spoke) in real life. The result, in various embodiments, is that natural language content 942 may be more impactful when a user (e.g. of client device 105) hears speech that sounds like it came from person 902, rather than generic artificially generated speech. The user may be able to pay closer attention and glean greater insight into information contained in synthetic audio content 940 than they otherwise would if contextual communication style 930 were not used to generate such content. In one embodiment, a computer system other than one of LLMs 125 may be used to perform the actual generation of synthetic audio content 940 (e.g. by transmitting contextual communication style 930 along with a written transcript, or by sending a written transcript alone to emulate an already created or already present communication style 930).

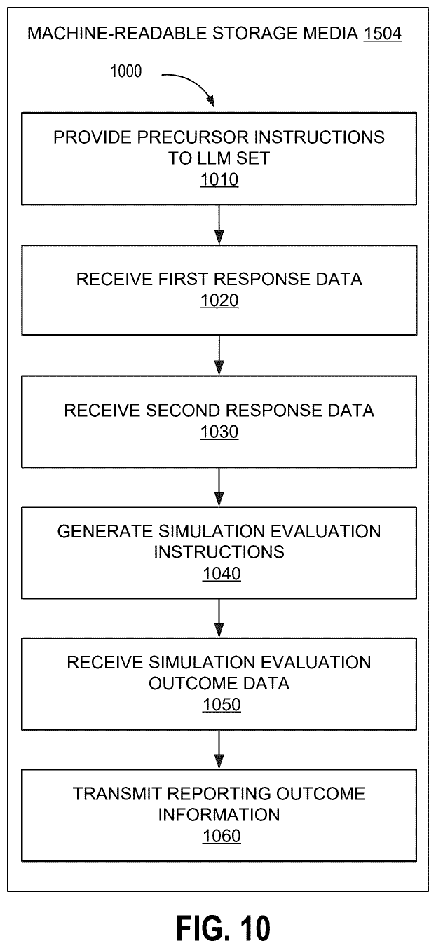

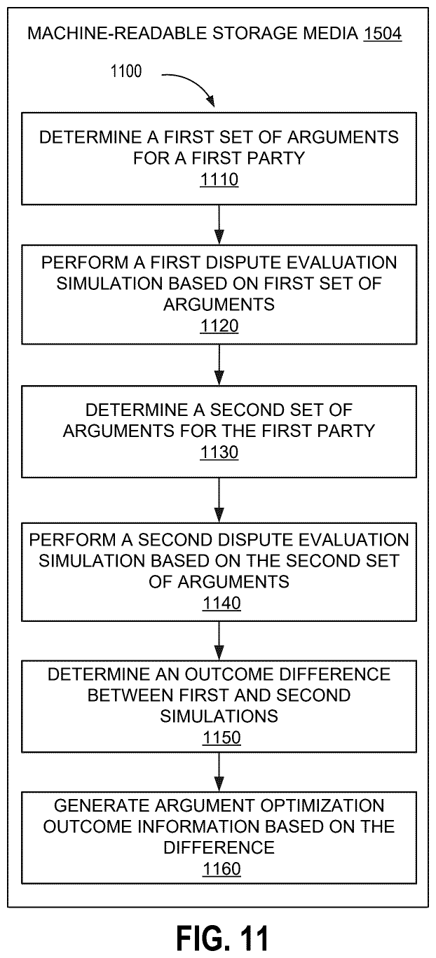

FIG. 10 illustrates a flowchart for a method 1000 that includes operations that may be taken by a computer system in relation to obtaining simulated evaluation outcome data in the context of a heterogenous large learning model (LLM) set, according to some embodiments. Operations described relative to FIG. 10, as with all operations described herein unless otherwise noted, may be performed by orchestration system 110 in some embodiments. Operations described relative to FIG. 10, as with all operations described herein unless otherwise noted, may be effectuated in the form of executing stored instructions (e.g. by a processor) to cause a computer system to perform one or more actions. Thus, in some embodiments, any or all aspects of operations described relative to FIG. 10 may be implemented by one or more particular executable computer instructions. Additionally, any or all aspects of operations described relative to FIG. 10 may be omitted, modified, or rearranged in any order other than the one depicted in various embodiments (which is also true for all operations described herein, e.g. operations described relative to FIGS. 11-14). Any or all aspects of operations described relative to FIG. 10 may be combined with or modified with respect to aspects of any other operations described relative to other figures or elsewhere herein (which is also true for all operations described herein, e.g. operations described relative to FIGS. 11-14).

Operation 1010 includes providing precursor instructions to an LLM set, as shown. This may include orchestration system 110 providing precursor instructions to LLM set 260, which may be a heterogenous LLM set having a plurality of LLMs with at least two of the LLMs being different from one another. The precursor instructions may have a first subset of precursor instructions that corresponds to a first evaluation precursor computing task and a second subset of precursor instructions that corresponds to a second evaluation precursor computing task. Such a precursor task may relate to a particular setup operation that is to be performed before a digital evaluation process can be executed or be concluded relative to a legal dispute. Thus, either the first or second subset of precursor instructions may correspond to functionality implemented by one or more of jurisdiction analyzer module 305, evaluator features module 310, evaluator generation module 315, dispute evaluator 360, case summary module 320, quality check module 322, evaluation form module 325, additional questions module 330, evaluation simulation module 340, report generation module 345, or audio generation module 350. In some embodiments, each or any of these structures/modules may have a corresponding set of precursor instructions used to initiate functionality or provide execution parameters. Precursor instructions may be provided simultaneously to LLM set 260 in one embodiment (e.g. as part of one data transmission), or may be provided at different times in other embodiments (e.g. one portion of the precursor instructions is sent initially and another portion is sent at a later time). Precursor instructions in operation 1010 may correspond to a legal dispute between at least a first party and a second party, and may be used to help set up and execute a simulated evaluation for such a dispute.

Precursor instructions may be provided to LLM set 260 in a variety of manners. In one embodiment, system 110 may transmit all or some portion of the precursor instructions to an LLM system 120 which may directly forward precursor instructions to one or more particular LLMs 125 (e.g. as based on addressing information or other information included in the precursor instructions that allows LLM system 120 to determine which of one or more hosted LLMs is to process and execute computing tasks corresponding to a particular portion of the precursor instructions). Precursor instructions may include portions of natural language, including statements, questions, and directives, according to various embodiments.

Operation 1020 includes receiving first response data, which may be received from a first LLM (e.g. 125A) of LLM set 260 in response to a first subset of precursor instructions sent to the first LLM. The first response data may include a range of information in various embodiments (which are not exclusive and may be suitably combined, as may all embodiments described herein). In one embodiment, the first response data may merely provide an indication of the success or failure of the precursor instructions. When success is indicated, method 1000 may proceed, but if an error condition has occurred, method 1000 may terminate in such embodiments. In another embodiment, the first response data may include particular output data from the first LLM. Such output data may include processing results, fetched information, or other information or data. Output data included in the first response data may include, for example, a civil case summary 630 or criminal case summary 640, civil verdict form 720, criminal verdict form 770, or reporting outcome information 820, according to embodiments.

Operation 1030 includes receiving second response data, which may be received from a second LLM (e.g. 125B) of LLM set 260 in response to a second subset of precursor instructions sent to the first LLM. This second response data may include a range of information in various embodiments and include any of the characteristics of the first response data as described above. Note that in further embodiments, similar third or additional precursor instructions may be sent to other LLMs (e.g. LLMs 125C, 125D, etc.) as well, and third or additional response data may likewise be received responsive to such instructions.

One purpose that may be served by segmenting precursor (or other) instructions to two or more LLMs (e.g. relative to operations 1020 and 1030) is to diversify simulation functionality and performance across different LLM types. Because different LLMs may have differing performance characteristics, some may excel at one type of computing task but perform worse than another LLM type for another type of computing task. Accordingly, by monitoring performance of computing tasks that may be coordinated by orchestration system 110, results of precursor instructions, dispute simulation output data, and other outputs from LLMs 125 may be determined to be superior when a particular LLM (e.g. LLM 125A) is used for one precursor computing task (e.g. performing jurisdictional analysis functions). The most suitable LLM of several possible choices may thus be used for one or more computing tasks to be performed in order to provide simulated results of a dispute evaluation, according to various embodiments.

In operation 1040, orchestration system 110 generates simulation evaluation instructions corresponding to a legal dispute according to an embodiment. This operation may be performed based on the first and second response data (or additional response data in some embodiments). For example, the response data may indicate that precursor computing tasks have executed successfully, and may also include particular output data from one or more of the modules within FIG. 3 (the term module may also be used herein to refer as such to dispute evaluator 360).

The generated simulation evaluation instructions may include portions of natural language, including statements, questions, and directives, according to various embodiments. Simulation evaluation instructions may further be generated based on outputs of the FIG. 3 modules. Thus, simulation evaluation instructions may include jurisdictional output (e.g. about a venue associated with a legal dispute), demographic output relative to potential juror population, etc.

As one simplified example, at least a portion of simulation evaluation instructions in one embodiment might include:
“Simulate the Smith v. Jones case using the determined likely jury demographics of Harris County as well as considering jurisdictional specifics to Harris County including sub-groups of potential jurors who may be more or less likely to be selected. Simulate 30 trials using 12 digital jurors per trial, and consider all case documents that have been labeled as evidence or admissible, except for email evidence exhibit #3. Run half the trials with email evidence exhibit #3 excluded, but the other half with it included. Consider the comparative result impact of including this evidence at trial. Also ask each simulated jury about Additional Questions 1-20, except exclude question 19 discussing email evidence exhibit #3 for the juries that do not hear about this evidence, but include question 20 (and exclude for the other juries) which asks jurors if they would have ruled differently if they knew an email from Jones to Smith existed that threatened to destroy Smith's automobile.”

As will be appreciated, simulation evaluation instructions may vary by embodiment, and may include or reference non-natural language content or other data in addition to natural language content. Results of simulation evaluation instructions (e.g. as sent to simulation evaluation module 340) may also be monitored for quality (e.g. by quality check module 322).

Simulation evaluation instructions, as well as precursor instructions, may be based on input provided by an end user (e.g. a user of client device 105) according to some embodiments. In one embodiment, an end user may provide natural language instructions to orchestration system 110, which may then interpret the instructions to then generate and execute precursor instructions and simulation evaluation instructions accordingly to fulfill the user's directives (e.g. via one or more LLMs). As an example, user instructions provided to orchestration system 110 might be “I want to see how Smith v. Jones will turn out depending on whether the jury hears about the email evidence.” Orchestration system 110 may then subsequently generate simulation evaluation instructions as shown slightly above.

Simulation evaluation instructions (and corresponding precursor instructions) may thus allow a user to mock-test different versions of evidence, argument, facts, or other aspects of a dispute. A defense attorney may have three different but related photographs of an accident scene, for example, and is trying to decide which one to make into a primary exhibit. Specific simulation evaluation instructions may be created requesting that the different photographs be used to see if anyone may be more compelling to a potential jury (or judge, etc.) than another. A plaintiff may want to know if asking for $50 Million in damages will be perceived as too greedy and actually result in a lesser award than if they only asked for $25 Million in damages. A criminal defendant may want to know if they have a better or worse chance of being acquitted of a charge if they take the witness stand to testify in their own defense. All these variations and many others are enabled via the present techniques.

If quality does not meet a threshold, then system 110 may automatically reformulate the simulation evaluation instructions and re-run a simulation evaluation. Automatic reformulation may include changing one or more sections of natural language phrasing within the simulation evaluation instructions based on quality deficiencies that are detected in output of evaluation simulation module 340. Such quality deficiencies may be detected via statistical analysis that shows an unusual variation beyond a specified threshold between jurors or juries regarding one or more aspects of the legal dispute (such as a decision regarding an issue in the case), for example. A quality deficiency may also be detected if natural language outputs of simulation evaluation module 340 do not meet a semantic quality check regarding grammar, clarity, or other aspects of language. Another type of quality deficiency may be detected if a specified threshold is met regarding a quantity of internally inconsistent output from jurors and/or juries is observed (e.g. a jury agreeing the defendant caused the plaintiff's injuries, that plaintiff's damage claim for $1 Million was highly credible, but then awarded the plaintiff zero dollars).

In operation 1050, orchestration system 110 receives simulation outcome evaluation data, according to an embodiment. The simulation outcome evaluation data may be received from LLM set 260 (e.g. from one or more LLMs within that set). The simulation outcome evaluation data is indicative of an outcome of the legal dispute with respect to at least a first party involved in the dispute, according to embodiments.

In operation 1060, orchestration system 110 may transmit reporting outcome information based on the simulated evaluation outcome data (e.g. to client device 105). Such reporting information may resemble reporting outcome information 820, according to some embodiments. In one embodiment, the reporting outcome information may simply by the simulation outcome evaluation data that is produced responsive to the simulation evaluation instructions. However, orchestration system 110 may also edit, format, add to, delete, or otherwise modify content included in reporting outcome information 820 before transmitting such information to client device 105. In another embodiment, a human user may perform a manual quality check on reporting outcome information before it is transmitted, though such a manual check is not required by the presently disclosed technology.

In another embodiment, method 1000 includes establishing, via instructions sent to a heterogenous LLM set, a dispute evaluator configured to produce simulated evaluation data indicative of the outcome, where the dispute evaluator comprises one or more simulated digital personas each having a plurality of corresponding data features. This may include, for example, sending one or more instructions (which may include natural language) to LLM set 260 e.g. instructing the creation of one or more digital evaluator personas, which may be jurors or juror panels, judges, arbitrators, or mediators according to various embodiments.

Establishing a dispute evaluator may comprise creating non-transient versions of digital personas (juror, panel, judge, etc.), which may remain indefinitely (or until deliberately deleted). Because dispute evaluator 360, as well as the digital personas may remain instantiated indefinitely, it can be re-used over and over again (including modification) to test new arguments, case documents, etc. as they become available-such as in response to motion hearings before a judge in a case, for example. Dispute evaluator 360 may remain instantiated within LLM set 260 along with instructions, associated output data of modules in FIG. 3, case documents, etc. (all information, data and instructions herein) which may also be modified, adjusted, edited, etc. as a legal dispute may evolve over time.

FIG. 11 illustrates a flowchart for a method 1100 that includes operations that may be taken by a computer system in relation to argument optimization in the context of a dispute, as may occur in the context of a heterogenous (LLM) set according to some embodiments.

As shown, operation 1110 includes determining a first set of legal arguments for (e.g. applicable to) a first party in regard to legal dispute involving the first party. This first set of legal arguments may have one or more arguments, and determining the first set can be performed in various ways. As one example, system 110 may direct an LLM (e.g. via instructions that include natural language, to analyze case documents, a case summary, or other information about a dispute to determine one or more arguments via textual analysis. Such arguments may include, for example, that “Bob Jones suffered back injuries due to being hit by BigCo's truck. BigCo was negligent, because the truck had poorly maintained brakes, and the driver was tired behind the wheel because BigCo had scheduled him all week for double shifts of 16 hours due to another driver unexpectedly quitting BigCo and leaving them short-staffed. The Supreme Court case Adams v. Zedd (1994) is the most relevant case law, and shows that precisely this type of conduct by BigCo is a clear indication of negligence.” Such arguments might also include “Whether or not BigCo was negligent does not matter, because Bob Jones failed to stop at a red light and was speeding 80 mph in a 40 mph zone when the accident occurred.” Note that a set of legal arguments, while being applicable to a first party (e.g. Bob Jones) may also be applicable to one or more additional parties (e.g. to BigCo, or to the driver of BigCo's truck).

Legal arguments in method 1100 may thus include one or more natural language statements with an intent to establish a fact or persuade an evaluator relative to an outcome for a dispute. Legal arguments may also include use of legal citations to decisions, statutes, regulations, or other authority. Arguments automatically determined by system 110 can be done using analysis of attorney or party notes, statements, demand letters, court pleadings or motions, or other documents, according to various embodiments. System 110 (e.g. via instructions to an LLM) may weight natural language, graphics, video, or audio according to a type of the information source, and look for commonalities or themes in determining the first set of legal arguments (which in some embodiments may correspond to the potentially most important or most relevant arguments for the outcome of a legal dispute). Thus, for example, if a police accident report says that BigCo's truck hit Mr. Jones, a video dashcam recording shows the truck driver saying “I'm so sorry I hit you, I never saw your car,” an initial demand letter from Mr. Jones's attorney references BigCo's truck, and so does a first filing of a lawsuit against BigCo, system 110 may determine that an informational threshold has been met, and include a related argument in the first set of documents. In some instances, a user may also specify one or more legal arguments for the first set of legal arguments (e.g. via a user interface of user device 105). In other embodiments, a hybrid system may be used in which a user may provide input (e.g. natural language input) about what legal argument should be included in the first set which may also be combined with legal arguments identified automatically by system 110.

Operation 1120, as shown, includes performing a first dispute evaluation based on a first set of legal arguments. This operation may include performing a first simulation, using a large language model (LLM), of a dispute evaluation process based on the first set of legal arguments, where the first simulation uses a plurality of simulated jurors having a set of data characteristic. Performing the dispute evaluation process may include using dispute evaluator 360, as discussed elsewhere herein and also with respect to FIGS. 4 and 10, for example. Accordingly, operation 1120 may involve the use of a mock jury panel, in one embodiment.

Operation 1130, as shown, includes generating a second set of one or more arguments for (e.g. applicable to) the first party. This second set of arguments may be generated similarly to operation 110, but may differ in at least one argument parameter from the first set of arguments.

An argument parameter may refer to a substantive difference in phrasing or presentation (e.g. regarding a fact or legal argument) that can affect an outcome of one or more issues related to a legal dispute. In one embodiment, a substantive difference may be determined by use of an LLM (or a survey of multiple LLMs). Thus, an LLM might receive an instruction in this regard to the effect of “Is there a substantive difference between [Argument X] and [Argument Y]?” An LLM affirming this (or a plurality or majority of a group of 2 or more LLMs affirming this) may thus reach a conclusion that an argument parameter has a substantive difference.

As an example, there may be no substantive difference between argument A that “the evidence will show that on the night of June 15, the defendant stabbed the victim with a knife” and argument B that “At 10 pm on June 15, the defendant was arrested carrying a knife, which we will show was used to stab the victim”. However, there may be a substantive difference between argument A and argument C that “On June 15, evidence will show the defendant left his house at 8 pm with the sole purpose of finding and viciously stabbing the victim with the brutal 12-inch blade he had hidden in his backpack, to seek revenge for damage he believed the victim had caused to his car.” These arguments may differ according to at least the parameters (1) presence of motive (e.g. no motive statement in argument A, but specific motive stated in argument C—revenge for car damage); (2) statements/facts regarding premeditation; and (3) descriptive or emotional language that may sway a jury (vicious stabbing, brutal blade). An LLM may also be used to characterize and apply labels to the argument parameters. Differences in argument parameters may also be specified by a user, in some embodiments.

Another example of differences between argument parameters includes an argument involving a liability case against a defendant in which a piece of evidence may be omitted entirely, or a description altered (e.g. a textual description of a video calling a vehicle impact “low speed” vs a “high energy collision”). Accordingly, an argument parameter may include a qualitative emotional impact (e.g. on a human being) that may be present based on one or more natural language words that are used. As per above, in some embodiments, qualitative emotional impact may be assessed by one or more LLMs that are directed to do so with natural language instructions. Ordering of presentation for information may also have an effect on an outcome of a case. As just one example, in a divorce trial involving division of assets and child custody, for example, a juror, judge, or other evaluator may be more likely to favor a first party over a second party if the first initial information they are presented is about the second party's extramarital affair. The evaluator may be more likely to favor the second party, however, if the initial information they are presented is about the first party's abusive pattern of behavior toward children. Ordering of information may affect how a juror mentally “frames” a dispute. This is yet another advantage of the present techniques, as digital evaluator 360 may evaluate many permutations of a legal dispute using a “stateless” paradigm in which a digital juror does not maintain a memory of prior ways or variations in how legal argument about a dispute was presented to them.

Generally, one or more causative factors may underly a difference between two different legal arguments. Such causative factors may include a failure to present first particular information relevant to an outcome of a legal dispute (e.g. mock jury did not know defendant possessed the knife because that evidence was excluded), a choice of phrase used in presentation of first particular information (“jagged steel blade” vs “pocketknife”), level of detail used to present information (“large delivery truck” vs “48 foot long and 12 foot tall delivery truck weighing 55,000 pounds), or an estimated impact of first particular information on an outcome of the legal dispute (e.g. mock jury found defendant's possession of the knife to be highly incriminating, mock jury gave relatively little weight to eyewitness testimony placing defendant within 6 blocks of the crime scene 30 minutes after the crime occurred). Various additional examples of differences between argument parameters, as well as underlying causative factors in a legal argument that may affect an outcome of a dispute, may be found throughout the specification, including the drawings.

Operation 1140, as shown, includes performing a second dispute evaluation simulation based on a second set of arguments. This may include performing a second simulation, using a second LLM (which may be the same LLM as in 1120, or may not be) of the dispute evaluation process using the second set of legal arguments, where the second simulation uses the plurality of simulated jurors having the set of data characteristics. However, while this operation may use the same dispute evaluator as in operation 1120, the second simulation may be performed in a stateless fashion. That is, digital mock jurors for operation 1140 may have no knowledge of the previous evaluation performed relative to operation 1120-thus avoiding a pitfall of the human mock jury process. Nonetheless, an exact same mock jury panel, with the exact characteristics that performed a first simulation evaluation, may perform the second simulation of the dispute evaluation process.

Operation 1150, as shown, includes determining a difference between an outcome of the first simulation and the second simulation. In some embodiments, this may be performed by a comparative analysis of outcome information (e.g. from dispute evaluator 360) that was generated relative to the first simulation and the second simulation. The difference in outcomes may be of many types, but one example includes a finding of civil liability or guilt for a crime (e.g. 76% of jurors found guilt in the first simulation, but only 57% in a second simulation), or an amount of damages awarded or a length of suggested sentence for a crime. Other differences may relate to more specific issues related to facts (e.g. emphasis or de-emphasis), case narratives, order of presentation of information, or word choice and phrasing. Any of the information presented in reporting outcome information 820, according to some embodiments, may differ between the first and second simulation, and be identified as a difference in outcomes. In some embodiments, determining the difference between outcomes may be performed by transmitting outputs from dispute evaluator 360 or reporting outcome information 820 (e.g. for the first and second simulations) to one or more LLMs, along with natural language instructions which may contain execution parameters. Such instructions might include, as a simplified example, a directive to “review the different simulation results and provide a summary of differences.” Other techniques, such as textual or data comparative analysis by system 110, may be used to determine a difference between the simulations.

Also, note that operations described relative to method 1100 may be applied to scenarios in which multiple executions of three or more different evaluation simulations are run and compared for differences. Similar techniques may be used to compare a third simulation to a second and first simulation, for example, and likewise for a fourth, fifth, or additional simulation. No fixed limit exists in this regard.

Operation 1160, as shown, includes generating argument optimization outcome information based on a difference in outcomes. Argument optimization outcome information may include a natural language description of at least one causative factor for a difference between the outcome of the first simulation and the second simulation in some embodiments. A causative factor may be identified via textual analysis, as may be conducted via sending instructions to an LLM. For a criminal trial, a causative factor of a 30% increase in “not guilty” simulated verdicts may be identified as “exclusion of the knife from evidence greatly increased doubt in many mock digital jurors,” for example.

Argument outcome optimization information may also be more detailed and may include strategic suggestions in various embodiments. Argument outcome optimization information may also include information that is specific to jurors having one or more particular data characteristics (e.g. demographics). For example, consider a scenario in which a difference between first and second simulations was a difference in information presentation order as well as emphasis level placed on certain facts or evidence. Argument outcome optimization information in such a scenario might include a natural language statement of “Younger jurors under age 35 were 45% more likely to find the defendant liable when the truck driver's DUI conviction was mentioned before hearing testimony in court from the truck driver. Most other jurors were also more likely as well (ranging from 3% to 32%), and only retired jurors over age 65 were less likely (by 10%). Strongly consider using this presentation strategy unless a significant number of jurors fit the over age 65 demographic.” Synthetic audio content may also be generated regarding argument optimization outcome information using techniques described herein.

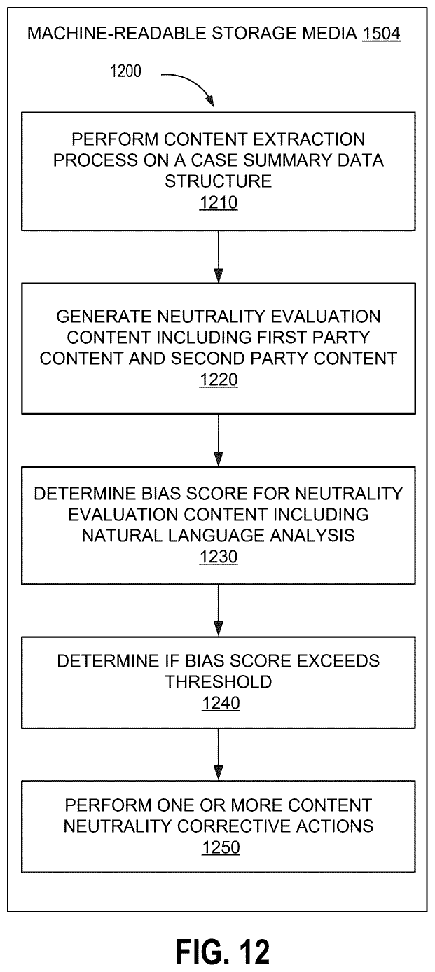

FIG. 12 illustrates a flowchart for a method 1200 that includes operations that may be taken by a computer system in relation to determining neutrality of input for a simulated evaluation of a dispute, as may occur in the context of a heterogenous LLM set according to some embodiments. It can be useful to have high quality input for a dispute evaluation simulation process as disclosed herein, because with a lower quality of input, results may be less reflective of a real-world resolution for a legal dispute. Method 1200 describes techniques that may be used to increase reliability and accuracy of simulation results according to various embodiments. In some embodiments, method 1200 relates to determining and improving the neutrality of a case summary data structure but related techniques may be used variously on input or output checks from any of the modules shown in FIG. 3.

Operation 1210, as shown, includes performing a content extraction process on a case summary data structure. This case summary data structure may be generated based on a plurality of media content items corresponding to a dispute involving at least a first party and a second party, such as case documents or other sources of information. The content extraction process may include parsing any or all data from the case summary data structure, and thus may include extracting an entirety of information contained in a case summary (as may be output by case summary module 320), or may include extracting only one or more portions of information contained in a case summary.

Operation 1220, as shown, includes causing generation of neutrality evaluation content. The neutrality evaluation content may be used to asses whether a presence of bias (e.g. lack of neutrality) may exist with respect to one or more parties. The neutrality content may include first party content or second party content, and may also include a synopsis of a dispute. Such a synopsis may include an overview of a dispute, such as “Smith is suing Jones for injuries sustained in a vehicle collision in Harris County, Texas. Smith contends Jones ran a red light and struck his car, causing him $750,000 in damages. Jones argues that it was Smith who ran the red light, not him, and owes nothing. A dashcam video from another vehicle shows the collision, but the parties disagree on whether the video shows who had the green light. Testimony from two eyewitness support Smith's position that Jones ran a red light.”

First party content in operation 1220 may include content corresponding to a first position of the first party with respect to a dispute. In the example above, first party content may include any portion of a case summary as discussed herein-for example, an overview of a plaintiff's case which may include key evidence or legal reasoning behind a request for a finding of liability and damages. Second party content may likewise be similar to the first party content, but may correspond to a position of a second party. Thus, second party content may include an overview of a defendant's case.

In some instances, a case summary (or other content for which neutrality is being evaluated) may be too lopsided (e.g. uneven) in favor of one party and tend to skew results in a simulated evaluation. An attorney for a first party might make overly optimistic assumptions, for example, about what evidence or arguments that a second party might use to refute a position of the first party. As one example, consider the following:

### First Party Content

Plaintiff's overview: Jones ran a red light as supported by two eyewitnesses and physical damage to the two vehicles involved. Jones has also received 8 moving violations from Harris County or Houston Police in the last 3 years and has a prior DUI conviction from last April. An expert witness (Dr. Cooper) will testify that Smith broke 3 lower vertebrae in the collision, and has suffered at least $100,000 in medical costs, pain, and suffering. Smith will testify he is no longer able to work as a plumber, which he planned to do for 10 more years before retirement. Another expert witness, economist Dr. Zhang, will testify that Smith will lose at least $650,000 in missing income over the next 10 years. Multiple eyewitnesses state that Jones ran the red light, even though dashcam video may be inconclusive.”
   Second Party Content Defendant's overview: Jones did not run a red light, as will be supported by a dashcam video and Jones's own testimony. Because Jones did not run the red light, he does not owe any damages to Smith.

In the above example, at least two neutrality issues may be detected via method 1200. While Jones has a rebuttal to Smith's contention that Jones ran the red light, he has no rebuttal to the history of moving violations or DUI conviction. Presuming such evidence would be admitted, such a rebuttal might include a statement (possibly with accompany evidence) that “Jones was formerly an alcoholic, but has been sober for over 15 months and has not received any traffic citations in that time. Jones's support group sponsor will testify to his sobriety.” Likewise on the issue of damages, Smith has two expert witnesses testifying on his behalf, but Jones has no rebuttal to the contention that $750,000 in damages should be awarded. A jury that hears two expert witnesses without any rebuttal of any kind may be highly likely to award requested plaintiff damages. Thus, a possible rebuttal strategy could include a statement that “text messages from Smith to his wife show that Smith planned to retire in 1 year, not 10 years. IRS tax records also show that Smith only reported $33,000 in income last year. Smith, at most, is owed $33,000 in lost wages.” Another possible rebuttal strategy could include a legal argument that “Smith's injuries do not qualify for pain and suffering damages under Texas state law, and at most he is owed $22,400 in documented medical costs.” Accordingly, if the above example of first party content and second party content is used by digital evaluator 360 to simulate an outcome of the legal dispute, the simulation may be highly likely to favor the plaintiff Smith in a manner that would not be reflective of likely real-world conditions.

Accordingly, operation 1230 may cause determination of a bias score that indicates an amount of bias in the neutrality evaluation content. The bias score may be determined with respect to at least a first position or a second position, and may be determined based on analyzing natural language content in the neutrality evaluation content. As one example, one or more LLMs may be used to analyze natural language content along with a suitable instruction, such as a directive to “Analyze the main positions of the plaintiff and the defendant. Indicate if any major contentions of either party appear to not be adequately rebutted by the other party or were not rebutted at all. Indicate if either party has an expert witness who is not rebutted, and provide a summary of the above.” Such directives, as with any other LLM instructions discussed herein with respect to various portions of this disclosure, may be templatized in some instances according to various case types (e.g. personal injury, contract dispute, felony criminal trial with bodily harm, misdemeanor criminal trial with no bodily harm, etc.) and stored for use by orchestration system 110. Other implementations are possible and contemplated, however.

Operation 1240, as shown, includes causing a determination of whether a bias score exceeds a specified bias threshold. This specified bias threshold may be qualitative or quantitative according to various embodiments. Thus, in one embodiment, the bias threshold may be a conditional amount of bias such as “substantial” or “severe.” In another embodiment, a bias threshold may fall within a numeric range, such as 0-100. Instructions used to determine a bias score may be based or otherwise adapted for use on such types of bias thresholds (e.g. “Give a 0 -100 score for how much bias exists with respect to plaintiff, with 0 representing no bias and 100 representing maximum bias”).

Operation 1250, as shown, includes causing one or more content neutrality corrective actions to be performed. The one or more content neutrality corrective actions may be based on the bias score exceeding the specified bias threshold. These actions vary by embodiment, but may include actions such as providing a warning to a user that bias exists, or disallowing a simulated evaluation (e.g. by digital evaluator 360) to occur based on a large amount of bias potentially existing. Another corrective action may include performing a second neutrality determination after a case summary has been modified (e.g. to make a case less lopsided). A simulated evaluation of a dispute may then be performed after it is determined that the modified case summary does not exceed a bias threshold.

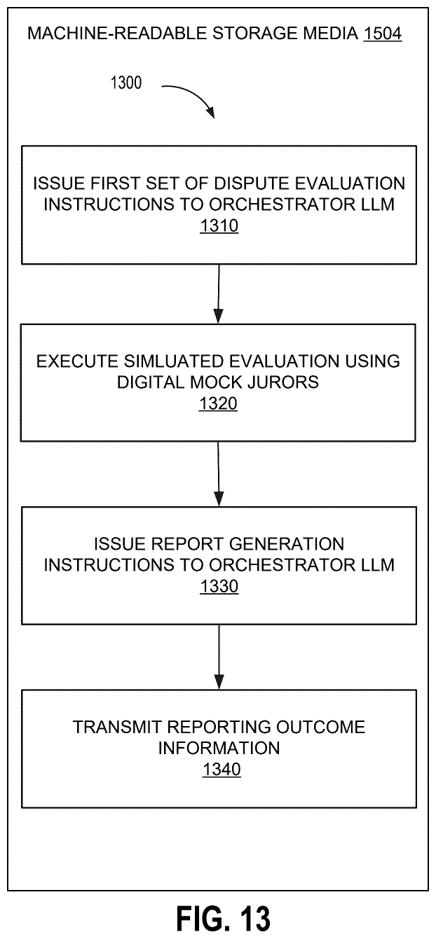

FIG. 13 illustrates a flowchart for a method 1300 that includes operations that may be taken by a computer system in relation to executing functional tasks related to simulated dispute evaluation, as may occur in the context of a system with a single LLM model according to some embodiments.

Various architectural and functional details have been described herein, often within the context of a heterogeneous LLM set. However, in some embodiments, disclosed methods and techniques may be used within the context of a single LLM. That is, two or more LLMs (which may be different types of LLM), are not necessary to implement and obtain various advantages of techniques herein. Unless otherwise noted, all operations described with respect to method 1300 may be implemented via a single LLM, which may be hosted on a system such as LLM system 120A, orchestration system 110, or another system, according to various embodiments. Using a single LLM may reduce operating costs, reduce use of computing resources, and speed up certain operations when compared to techniques that employ multiple-LLM architectures, according to various embodiments.

Thus, all operations and techniques described herein (e.g. regarding simulated dispute evaluation) may be suitably used by a single LLM unless otherwise specifically indicated (such as techniques that may use two or more LLMs to achieve a purpose that may not be obtainable using only one LLM, as may be described according to some embodiments). Thus, any or all of the modules of FIG. 3, as well as functionality associated with those modules described herein, may be implemented in a single LLM. As used herein, a first computer system issuing instructions to an LLM may indicate that the first computer system issues instructions to an LLM that is also hosted by the first computer system, but may also indicate that the first computer system issues (e.g. via a network) instructions to an LLM that is hosted by a different computer system.

Operation 1310, as shown, includes issuing, to an orchestrator LLM, a first set of dispute evaluation instructions corresponding to a legal dispute between at least a first party and a second party. The orchestrator LLM may have any or all of the characteristics of any LLM described herein. The first set of dispute evaluation instructions may include jurisdiction analysis instructions comprising a natural language directive to provide jurisdiction data regarding one or more factors affecting jury selection criteria corresponding to a venue. These jurisdiction analysis instructions may be issued to jurisdiction analyzer module 305 in some instances. The first set of dispute evaluation instructions may include demographic generation instructions comprising a natural language directive to provide demographic data regarding one or more first data characteristics of potential jurors corresponding to a venue. Such demographic generation instructions may be issued to evaluator features module 310 in some cases. The first set of dispute evaluation instructions may also include evaluator generation instructions comprising a natural language directive to create a plurality of digital mock jurors based on the jurisdiction data and the demographic data. Such evaluator generation instructions may be issued to evaluator generation module 315 (which may be used to create dispute evaluator 360).

Operation 1320, as shown, includes executing, via the orchestrator LLM and using the plurality of digital mock jurors, a simulated evaluation of the legal dispute that produces simulated evaluation outcome data indicative of an outcome of the legal dispute with respect to at least the first party. This simulated evaluation of the legal dispute may correspond to operations performed by evaluation simulation module 340, in some embodiments.

Operation 1330, as shown, includes issuing, to the orchestrator LLM, report generation instructions comprising a natural language directive to create reporting outcome information based on the simulated evaluation outcome data. These report generation instructions may correspond to instructions that are sent to report generation module 345, according to various embodiments. This reporting outcome information may correspond to any or all content contained within reporting outcome information 820.

Operation 1340, a shown, includes transmitting the reporting outcome information to a client device. In one embodiment, this includes making a transmission to client device 105, but transmission may also be made to other systems.

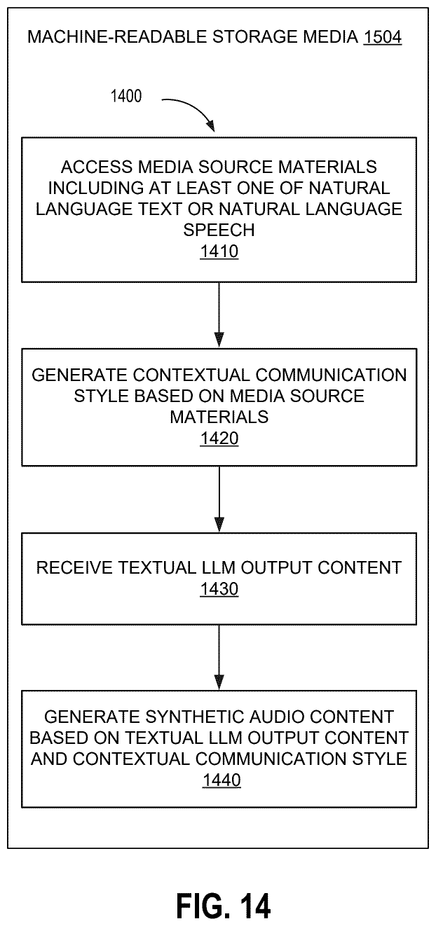

FIG. 14 illustrates a flowchart for a method 1400 that includes operations that may be taken by a computer system in relation to generation of synthetic audio content as may be used in connection with simulated dispute evaluation, according to some embodiments. Audio content may be useful instead of text content for a variety of reasons, including convenience. One challenge with audio content in the context of dispute evaluation, however, is producing content that is accurate, useful, and of high quality. A user who hears audio content that is of poor quality may tend to discount the accuracy or the usefulness of the content, even if those aspects are generally good. Accordingly, present techniques describe ways in which this challenge can be overcome. Aspects described above relative to FIG. 9 may be applied to operations described relative to method 1400 according to various embodiments.

Operation 1410, as shown, includes accessing media source materials including at least one of natural language text or natural language speech. The natural language text may be written words or spoken words by a particular individual, and the natural language speech may be speech that was uttered by a particular individual. The media source materials may include media source materials 920 in some embodiments. Thus, media source materials may include video recordings (with an audio component), audio only recordings, written interview transcripts, books, articles, etc. In some embodiments, natural language speech may be usable according to techniques below to capture how a particular person sounds when talking, while natural language text may be usable to capture phrasing, word choice, and other related aspects (which can also be captured via a speech recording in some embodiments, however).

Operation 1420, as shown, includes generating a contextual communication style based on media source materials (e.g. from operation 1410). This may include processing the media source materials by performing operations such as analyzing sound waveforms corresponding to speech by the particular individual, correlating such waveforms to particular natural language words or portions of words, applying modifications based on variations in accent or pronunciation, performing textual analysis regarding word and phrasing choices, etc. In some embodiments, a contextual communication style is represented as a collection of digital information that provides a mapping between written words and/or portions of words to a corresponding sound waveform library collection (e.g. the written word “aunt” may be pronounced according to a certain waveform, or group of waveforms, the syllable “oo” may be pronounced according to a different waveform or group of waveforms, etc.). The communication style may be contextual, as discussed relative to FIG. 9—such as a legal analysis context, for example.

Operation 1430, as shown, includes receiving textual LLM output content corresponding to a legal dispute involving at least a first party and a second party. This textual LLM output content may be received from digital evaluator 360, evaluation simulation module 340, or report generation module 345, according to various embodiments. In some embodiments, the textual LLM output content may include any or all portion of reporting outcome information 820.

Operation 1440, as shown, includes generating synthetic audio content. This may be performed based on textual LLM output content and a contextual communication style corresponding to a particular individual. The synthetic audio content may include stylized natural language speech that simulates the contextual communication style for the particular individual, and the stylized natural language speech may include one or more sentences related to a first party involved in a legal dispute or one or more sentences related to a second party involved in a legal dispute. In some instances, the synthetic audio content may include an audio summary of key findings or strategic considerations in regard to a legal dispute. The synthetic audio content may be kept within an allowable time or range of time at normal playback speed (e.g. less than 2 minutes, less than 5 minutes, 5-10 minutes, or some other range of time or amount of time).

Generating the synthetic audio content may thus include compressing, summarizing, or otherwise reducing an amount of textual content that is present. As an example, reporting outcome information 820 may be too lengthy to read in its entirety to fit within an applicable time limit for the synthetic audio content. Accordingly, content in outcome information 820 may be reduced in scope. In one embodiment, operation 1440 includes transmitting instructions to an LLM to summarize the textual content into one or more key portions. A resulting summary of the textual content may be transmitted to system 110, for example, which may allow a desired time limit for the synthetic audio content to be met.

Generating the synthetic audio content may further include creating one or more digital waveforms that mimic a speech style of the particular individual, allowing the synthetic audio content to authentically sound like a particular individual (e.g., mimicking that individual's sound and speech patterns). This may be performed in some embodiments by transmitting summarized textual content to an external system and receiving one or more waveforms in reply, or by directly employing text-to-speech algorithms as may be present at or available via orchestration system 110. Additional detail in this regard is also discussed relative to FIG. 9.

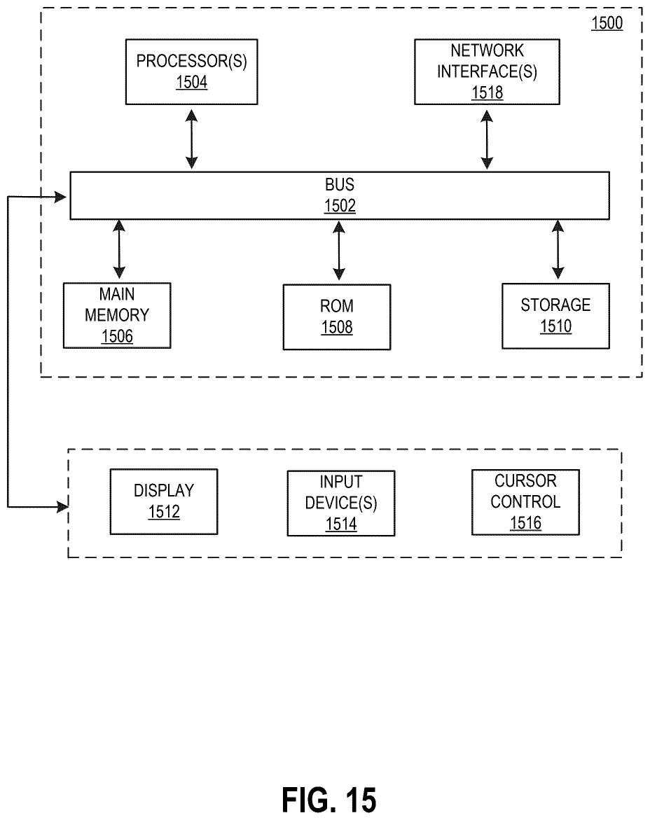

FIG. 15 depicts a block diagram of an example computer system 500 in which various examples of the disclosed technology described herein may be implemented. The computer system 1500 includes a bus 1502 or other communication mechanism for communicating information, one or more hardware processors 1504 coupled with bus 1502 for processing information. Hardware processor(s) 1504 may be, for example, one or more general purpose microprocessors.

The computer system 1500 also includes a main memory 1506, such as a random access memory (RAM), cache and/or other dynamic storage devices, coupled to bus 1502 for storing information and instructions to be executed by processor 1504. Main memory 1506 also may be used for storing temporary variables or other intermediate information during execution of instructions to be executed by processor 1504. Such instructions, when stored in storage media accessible to processor 1504, render computer system 1500 into a special-purpose machine that is customized to perform the operations specified in the instructions.

The computer system 1500 further includes a read only memory (ROM) 1508 or other static storage device coupled to bus 1502 for storing static information and instructions for processor 1504. A storage device 1510, such as a magnetic disk, optical disk, or USB thumb drive (Flash drive), etc., is provided and coupled to bus 1502 for storing information and instructions.

The computer system 1500 may be coupled via bus 1502 to a display 1512, such as a liquid crystal display (LCD) (or touch screen), for displaying information to a computer user. An input device 1514, including alphanumeric and other keys, is coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. In some examples, the same direction information and command selections as cursor control may be implemented via receiving touches on a touch screen without a cursor.

The computing system 1500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,“ and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1500 may implement the techniques described herein using customized hard-wired logic, one or more ASICs or FPGAs, firmware and/or program logic which in combination with the computer system causes or programs computer system 1500 to be a special-purpose machine. According to one example of the disclosed technology, the techniques herein are performed by computer system 1500 in response to processor(s) 1504 executing one or more sequences of one or more instructions contained in main memory 1506. Such instructions may be read into main memory 1506 from another storage medium, such as storage device 1510. Execution of the sequences of instructions contained in main memory 1506 causes processor(s) 1504 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1510. Volatile media includes dynamic memory, such as main memory 1506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1502. Transmission media can also take the form of acoustic or light waves, such as those generated during radio-wave and infra-red data communications.

The computer system 1500 also includes a communication interface 1518 coupled to bus 1502. Network interface 1518 provides a two-way data communication coupling to one or more network links that are connected to one or more local networks. For example, communication interface 1518 may be an integrated services digital network (ISDN) card, cable modem, satellite modem, or a modem to provide a data communication connection to a corresponding type of telephone line. As another example, network interface 1518 may be a local area network (LAN) card to provide a data communication connection to a compatible LAN (or WAN component to communicate with a WAN). Wireless links may also be implemented. In any such implementation, network interface 1518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through communication interface 1518, which carry the digital data to and from computer system 1500, are example forms of transmission media.

The computer system 1500 can send messages and receive data, including program code, through the network(s), network link and communication interface 1518. In the Internet example, a server might transmit a requested code for an application program through the Internet, the ISP, the local network and the communication interface 1518.

The received code may be executed by processor 1504 as it is received, and/or stored in storage device 1510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1500.

As used herein, the term “or” is to be construed inclusively unless otherwise indicated. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps. Terms such as “first, second” etc. are intended to be descriptive, and do not imply a specific ordering (e.g. spatial, temporal, or otherwise) unless specifically indicated. Thus, a “first” transmission of information does not necessarily occur in time prior to a “second” transmission, for example.

The term “configured to” as used herein is not intended to invoke means-plus-function usage unless specifically noted, but rather, indicates that a component (e.g. structure) contains stored logic (and associated data in some embodiments) executable to cause that component to perform the actions indicated. Such components may include software instructions stored on a non-transitory computer-readable medium, in which case the instructions may be encoded with particular logic that causes a described action, operation, and/or effect to occur. Such components may also include hardware (e.g. EEPROM, ASIC, etc.) and in such cases the logic to cause a described action, operation, and/or effect to occur may be encoded within the hardware itself.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A system, comprising:
a processor; and
a non-transitory computer-readable medium having stored thereon instructions that are executable by the processor to cause the system to perform operations comprising:
determining a first set of legal arguments applicable to a first party in regard to a legal dispute involving the first party;
performing a first simulation, using a first large language model (LLM), of a dispute evaluation process based on the first set of legal arguments, wherein the first simulation uses a dispute evaluator comprising one or more digital entities each having a respective set of data characteristics;
determining a second set of legal arguments applicable to the first party in regard to the legal dispute, wherein the second set of legal arguments differs from the first set of legal arguments with respect to at least one argument parameter;
performing a second simulation, using a second LLM, of the dispute evaluation process using the dispute evaluator comprising the one or more digital entities;
determining a difference between an outcome of the first simulation and the second simulation; and
generating argument optimization outcome information based on the difference.

2. The system of claim 1, wherein the argument optimization outcome information includes a natural language description of at least one causative factor for the difference between the outcome of the first simulation and the second simulation.

3. The system of claim 1, wherein the operations further comprise:
transmitting instructions to the first LLM that include a directive for the first LLM to use one or more case documents to automatically determine the first set of legal arguments.

4. The system of claim 3, wherein the operations further comprise:
transmitting the one or more case documents to the first LLM prior to determining the first set of legal arguments.

5. The system of claim 1, wherein the operations further comprise:
receiving, from a user of a user device, user legal argument information; and
wherein determining the first set of legal arguments includes transmitting, to the LLM, the user legal argument information and instructions that include a directive for the LLM to use the user legal argument information in generating the first set of legal arguments.

6. The system of claim 1, wherein the operations further comprise:
establishing the dispute evaluator via an LLM computer system, comprising transmitting instructions to the LLM computer system that include parameters regarding a composition of one or more mock jury panels, wherein the parameters regarding the composition are based on a venue corresponding to the legal dispute.

7. The system of claim 1, wherein the LLM is hosted by a first LLM computer system, and wherein the first LLM is part of a heterogenous LLM set comprising a plurality of LLMs and a plurality of LLM computer systems including the first LLM computer system.

8. The system of claim 1, wherein the operations further comprise:
generating synthetic audio content based on the argument optimization outcome information; and
transmitting the synthetic audio content to a user device.

9. A method, comprising:
determining, by a computer system, a first set of legal arguments applicable to a first party in regard to a legal dispute involving the first party;
performing a first simulation, using a first large language model (LLM), of a dispute evaluation process based on the first set of legal arguments, wherein the first simulation uses a dispute evaluator comprising one or more digital entities each having a respective set of data characteristics;
determining, by the computer system, a second set of legal arguments applicable to the first party in regard to the legal dispute, wherein the second set of legal arguments differs from the first set of legal arguments with respect to at least one argument parameter;
performing a second simulation, using a second LLM, of the dispute evaluation process using the dispute evaluator comprising the one or more digital entities;
determining a difference between an outcome of the first simulation and the second simulation; and
generating argument optimization outcome information based on the difference.

10. The method of claim 9, wherein performing the second simulation comprises the dispute evaluator performing a current evaluation of the second set of legal arguments without the dispute evaluator retaining information regarding a previous evaluation of the first set of legal arguments, and wherein a composition of the dispute evaluator is not changed between performing the previous evaluation and the current evaluation.

11. The method of claim 9, wherein the differing at least one argument parameter comprises an ordering of presentation for natural language information within the first set of legal arguments.

12. The method of claim 9, wherein the differing at least one argument parameter comprises a qualitative emotional impact of a plurality of natural language words included in the first set of legal arguments.

13. The method of claim 9, wherein the first LLM and the second LLM are a same LLM.

14. The method of claim 9, wherein the first LLM and the second LLM are different LLMs hosted respectively on a first LLM computer system and a second LLM computer system, the first LLM computer system corresponding to a first entity and the second LLM computer system corresponding to a different, second entity.

15. The method of claim 9, wherein the argument optimization outcome information includes one or more natural language descriptions of one or more causative factors for the determined difference between the outcome of the first simulation and the second simulation.

16. The method of claim 15, wherein the one or more causative factors include at least one of an ordering of presentation of content, a failure to present first particular information relevant to an outcome of the legal dispute, a choice of phrase used in presentation of the first particular information, a level of detail used to present the first particular information, or an estimated impact of the first particular information on the outcome.

17. The method of claim 9, further comprising:
generating synthetic audio content based on the argument optimization outcome information, wherein the synthetic audio content corresponds to a communication style of a particular individual; and
transmitting the synthetic audio content to a user device.

18. A non-transitory computer-readable medium having stored thereon instructions that are executable by a processor of a computer system to cause the computer system to perform operations comprising:
determining a first set of legal arguments applicable to a first party in regard to a legal dispute involving the first party;
performing a first simulation, using a first large language model (LLM), of a dispute evaluation process based on the first set of legal arguments, wherein the first simulation uses a dispute evaluator comprising one or more digital entities each having a respective set of data characteristics;
determining a second set of legal arguments applicable to the first party in regard to the legal dispute, wherein the second set of legal arguments differs from the first set of legal arguments with respect to at least one argument parameter;
performing a second simulation, using a second LLM, of the dispute evaluation process using the dispute evaluator comprising the one or more digital entities, wherein performing the second simulation comprises the dispute evaluator performing a current evaluation of the second set of legal arguments without the dispute evaluator retaining information regarding a previous evaluation of the first set of legal arguments, and wherein a composition of the dispute evaluator is not changed between performing the previous evaluation and the current evaluation;
determining a difference between an outcome of the first simulation and the second simulation; and
generating argument optimization outcome information based on the difference.

19. The non-transitory computer-readable medium of claim 16, wherein the operations further comprise:
receiving, from a user of a user device, user legal argument information; and
wherein determining the first set of legal arguments includes transmitting, to the LLM, the user legal argument information and instructions that include a directive for the LLM to use the user legal argument information in generating the first set of legal arguments.

20. The non-transitory computer-readable medium of claim 16, wherein the operations further comprise:
establishing the dispute evaluator via an LLM computer system, comprising transmitting instructions to the LLM computer system that include parameters regarding a composition of one or more mock jury panels, wherein the parameters regarding the composition are based on a venue corresponding to the legal dispute.
